(19) United States
(12) Patent Application Publication
(10) Pub. No.: US 2008/0102404 A1
(43) Pub. Date: May 1, 2008

(54) ALUMINUM ALLOY PLATE AND SUPPORT FOR LITHOGRAPHIC PRINTING PLATE

(75) Inventors: Hiroshi TASHIRO, Haibara-gun (JP); Hirokazu SAWADA, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/877,393

(22) Filed: Oct. 23, 2007

(30) Foreign Application Priority Data
Oct. 27, 2006 (JP) 2006-292990

(51) Int. Cl. G03C 1/77

(52) U.S. Cl. 430/278.1

(57) ABSTRACT

An aluminum alloy plate for lithographic printing that is capable of obtaining a lithographic printing plate support which is free from appearance defects and has a uniform surface after electrolytic graining treatment and of obtaining a lithographic printing plate having a long press life and an excellent scumming resistance is provided. The aluminum alloy plate for a lithographic printing plate is obtained by continuous casting in which an aluminum alloy melt is fed through a melt feed nozzle between a pair of cooling rollers and rolled as it is being solidified by the pair of cooling rollers, wherein the aluminum alloy plate contains 0.10 to 0.20 wt % of silicon and 0.10 to 0.40 wt % of iron, and wherein the aluminum alloy plate contains in solid solution 200 to 600 ppm of silicon and not more than 250 ppm of iron.

The entire contents of all documents cited in this specification are incorporated herein by reference.

### BACKGROUND OF THE INVENTION

The present invention relates to an aluminum alloy plate for a lithographic printing plate and a support for a lithographic printing plate that uses this aluminum alloy plate.

A photosensitive presensitized plate for a lithographic printing plate that uses an aluminum alloy plate as the support has been widely used in offset printing.

Rolled plates having a thickness of 0.1 to 0.5 mm are generally used for the aluminum alloy plate, and exemplary plates that may be used include JIS 1000 series materials and JIS 3000 series materials.

Such aluminum alloy plates are generally produced by using a semi-continuous casting process (direct chill casting) to cast a slab from an aluminum alloy melt, then subjecting the slab to soaking treatment, followed by hot rolling, cold rolling and, if necessary, annealing.

On the other hand, lithographic printing plate supports are generally produced by a known process which involves subjecting the surface of a sheet- or coil-shaped aluminum alloy plate to surface roughening treatment and anodizing treatment.

Presensitized plates are generally produced by a known process which involves applying a photosensitive liquid onto a lithographic printing plate support, then drying the applied photosensitive liquid to form an image recording layer thereon and optionally cutting the support having the image recording layer formed thereon into a desired size. The presensitized plates produced are then subjected to image exposure and development to yield lithographic printing plates.

It is known that electrochemical graining treatment (hereinafter also referred to as “electrolytic graining treatment”) in an acidic solution as well as surface treatment and application of an undercoat liquid following anodizing treatment are effective to carry out in the above process in order to improve the adhesion between the image recording layer and the lithographic printing plate support.

In the case where surface roughening treatment including electrolytic graining treatment is carried out, the surface roughening treatment is known to cause fine irregularities (pits) on the surface of the lithographic printing plate support.

It has been considered that a presensitized plate having excellent printability (in particular, having a long press life and an excellent scumming resistance) is obtained by having uniform and larger pit diameters or having larger pit depths. This is based on the finding that, in image areas, the image recording layer after a large number of impressions have been made is not readily peeled off the lithographic printing plate support because of the strong adhesion between the image recording layer and the lithographic printing plate support, whereas scumming does not readily occur in non-image areas that can hold a large amount of fountain solution on their surfaces.

From these points of view, have been proposed various processes for improving the shape of pits produced by electrolytic graining treatment and the uniformity of the surface of a lithographic printing plate support following electrolytic graining treatment (see JP 2000-108534 A, JP 2000-37965 A, JP 2000-37964 A).

However, the processes mentioned in these patent documents are directed to materials having a high aluminum (Al) purity, and application of these processes to aluminum materials having a high alloy content have raised the following problems.

More specifically, JP 07-173563 A (corresponding to EP 0640694 A) refers to an aluminum material of a high alloy content and discloses a “continuously cast and rolled aluminum alloy substrate for an electrolytically grainable lithographic printing plate, consisting of 0.20 to 0.80 wt % of Fe and the balance of Al, grain-refining elements and unavoidable impurities including 0.3 wt % or less of Si and 0.05 wt % or less of Cu, the amount of Fe present in solid solution being not more than 250 ppm, the amount of Si present in solid solution being not more than 150 ppm, and the amount of Cu present in solid solution being not more than 120 ppm”.

Such alloy elements include those in the state of solid solution in aluminum, those deposited as metal components, and those present as intermetallic compounds. Because of the necessity of using the intermetallic compounds in specified amounts or less, keeping the iron (Fe), silicon (Si) and copper (Cu) contents in solid solution at low levels as described in JP 07-173563 A increases the deposited components, thus causing such a defect as lowered resistance to severe ink scumming. It has been also difficult to keep the contents in solid solution at low levels while secondary phase particles are crystallized finely and uniformly.

“Severe ink scumming” as used herein refers to contamination in the form of spots and rings that appears on the printed medium such as paper as a result of the tendency for ink to adhere to non-image areas of the printing plate surface when printing is carried out with repeated interruptions.

In order to solve this problem, commonly assigned JP 2005-89846 A proposes “an aluminum alloy blank for a lithographic printing plate made of a continuously cast flat-rolled aluminum alloy plate, the aluminum alloy blank for a lithographic printing plate comprising: iron in a range of 0.20 to 0.80 wt %; and the balance being aluminum, a crystal grain refining element, and unavoidable impurity elements, wherein, a content of silicon is in a range of 0.02 to 0.30 wt % and a content of copper is equal to or below 0.05 wt % among the impurity elements, and a solid solution amount of silicon is in a range of 150 ppm to 1500 ppm inclusive”.

### SUMMARY OF THE INVENTION

Nevertheless, in the case in which an aluminum material having a high alloy content as described in JP 07-173563 A was used in the aluminum alloy blank for a lithographic printing plate, simplification of the process of producing the blank, and reduction of the production costs and production time could not be sufficiently achieved. When producing a support for a lithographic printing plate, the support did not have a uniform surface after electrolytic graining treatment and showed appearance defects. In addition, the lithographic printing plate obtained by using such a lithographic printing plate support was inferior in press life and scumming resistance.

The inventors of the present invention have found that even a lithographic printing plate support that is produced by subjecting the aluminum alloy blank for a lithographic printing plate described in JP 2005-89846 A to surface roughening treatment may have an appearance defect.

Under these circumstances, an object of the present invention is to provide an aluminum alloy plate for lithographic printing that is capable of obtaining a lithographic printing plate support which is free from appearance defects and has a uniform surface after electrolytic graining treatment and of obtaining a lithographic printing plate having a long press life and an excellent scumming resistance, as well as the lithographic printing plate support using the aluminum alloy plate described above and a presensitized plate obtained therefrom.

Another object of the present invention is to provide an aluminum alloy plate for lithographic printing that is capable of simplifying the production process while reducing the production costs and the production time, as well as a lithographic printing plate support using the aluminum alloy plate described above and a presensitized plate obtained therefrom.

The inventors of the present invention have made intensive studies to achieve the above objects and found that a lithographic printing plate support which is free from appearance defects and has a uniform surface after electrolytic graining treatment, and a lithographic printing plate which has a long press life and an excellent scumming resistance can be obtained by using an aluminum alloy plate for lithographic printing in which the silicon and iron contents and the silicon and iron contents in solid solution lie within specified ranges.

Accordingly, the invention provides the following (1) to (11).

(1) An aluminum alloy plate for a lithographic printing plate obtained by continuous casting in which an aluminum alloy melt is fed through a melt feed nozzle between a pair of cooling rollers and rolled as it is being solidified by the pair of cooling rollers, wherein the aluminum alloy plate contains 0.10 to 0.20 wt % of silicon and 0.10 to 0.40 wt % of iron, and wherein the aluminum alloy plate contains in solid solution 200 to 600 ppm of silicon and not more than 250 ppm of iron.

(2) The aluminum alloy plate for a lithographic printing plate according to (1) above, wherein copper is contained in an amount of not more than 0.02 wt %.

(3) A lithographic printing plate support obtained by subjecting a surface of the aluminum alloy plate for a lithographic printing plate according to (1) or (2) above to a surface roughening treatment including an electrochemical graining treatment.

(4) The lithographic printing plate support according to (3) above, wherein the surface roughening treatment further includes an alkali etching treatment (first alkali etching treatment) prior to the electrochemical graining treatment.

(5) The lithographic printing plate support according to (3) or (4), wherein pits formed by the electrochemical graining treatment have uniform diameters of 0.01 to 1.5 μm.

(6) The lithographic printing plate support according to any one of (3) to (5) above, wherein the surface roughening treatment further includes an alkali etching treatment (second alkali etching treatment) following the electrochemical graining treatment.

(7) The lithographic printing plate support according to (6) above, wherein the electrochemical graining treatment is carried out at a current density of at least 5 A/dm², and wherein at least 0.1 g/m² of material is dissolved from the surface of the aluminum alloy plate for a lithographic printing plate by the alkali etching treatment (second alkali etching treatment) following the electrochemical graining treatment.

(8) The lithographic printing plate support according to any one of (3) to (7) above, wherein the electrochemical graining treatment is a treatment carried out with an alternating current having a trapezoidal waveform in a nitric acid-containing electrolytic solution.

(9) The lithographic printing plate support according to any one of (3) to (7) above, wherein the electrochemical graining treatment is a treatment carried out with an alternating current having a sinusoidal waveform in a hydrochloric acid-containing electrolytic solution.

(10) The lithographic printing plate support according to (3) above obtained by the surface roughening treatment which includes a first electrochemical graining treatment carried out in a nitric acid-containing electrolytic solution so that a total amount of electricity in an anodic reaction is from 65 to 500 C/dm², a first alkali etching treatment in which at least 0.1 g/m² of material is dissolved from the surface of the aluminum alloy plate for a lithographic printing plate, a second electrochemical graining treatment carried out in a hydrochloric acid-containing electrolytic solution so that a total amount of electricity in an anodic reaction is from 25 to 100 C/dm², and a second alkali etching treatment in which at least 0.03 g/m² of material is dissolved from the surface of the aluminum alloy plate for a lithographic printing plate.

(11) A presensitized plate comprising: the lithographic printing plate support according to any one of (3) to (10) above; and an image recording layer formed on the lithographic printing plate support.

As will be described later, the invention can provide an aluminum alloy plate for lithographic printing that is capable of obtaining a lithographic printing plate support which is free from appearance defects and has a uniform surface after electrolytic graining treatment and of obtaining a lithographic printing plate having a long press life and an excellent scumming resistance, as well as the lithographic printing plate support using the aluminum alloy plate described above and a presensitized plate obtained therefrom.

The aluminum alloy plate for lithographic printing of the invention can simplify the production process compared with the conventional processes while reducing the production costs and the production time and is therefore very useful.

### BRIEF DESCRIPTION OF THE DRAWINGS

In the accompanying drawings:

FIG. 1 is a graph showing an example of an alternating current waveform that may be used to carry out electrochemical graining treatment in a method of manufacturing a lithographic printing plate support of the invention;

FIG. 2 is a side view of a radial electrolytic cell that may be used in electrochemical graining treatment with alternating current in a method of manufacturing the lithographic printing plate support of the invention;

FIG. 3 is a schematic view of an anodizing apparatus that may be used to carry out anodizing treatment in a method of manufacturing the lithographic printing plate support of the invention;

FIG. 4 is a graph showing an example of a sinusoidal waveform that may be used in electrochemical graining treatment in a method of manufacturing the lithographic printing plate support of the invention;

FIG. 5 is a side view illustrating the concept of a brush graining step that may be used to carry out mechanical graining treatment in the manufacture of the lithographic printing plate support of the invention; and

FIG. 6 is a schematic view of another anodizing apparatus that may be used to carry out anodizing treatment in the manufacture of the lithographic printing plate support of the invention.

### DETAILED DESCRIPTION OF THE INVENTION

The invention is described in detail below.

### [Lithographic Printing Plate Support]

### <Aluminum Alloy Plate (Rolled Aluminum)>

The aluminum alloy plate for a lithographic printing plate of the invention to be described later (hereinafter referred to as “aluminum alloy plate of the invention”) is used for the lithographic printing plate support of the invention. The aluminum alloy contains aluminum, iron and silicon as essential alloying ingredients and may contain copper as an impurity.

Silicon is an element which is contained in an amount of around 0.03 to 0.1 wt % as an inadvertent impurity in the aluminum ingot serving as the starting material. A very small amount of silicon is often intentionally added to prevent variations due to starting material differences. Silicon is present in the state of solid solution in aluminum or as an intermetallic compound or a single deposit.

Silicon is known to affect electrolytic graining treatment.

Accordingly, the inventors of the invention focused particular attention on the content in solid solution and found that keeping the silicon content in solid solution at a specified level when an aluminum alloy plate produced by continuous casting is subjected to electrolytic graining treatment is effective at achieving an excellent stability in electrolytic graining treatment.

In the invention, the silicon content is in a range of 0.10 to 0.20 wt % and the silicon content in solid solution is in a range of 200 to 600 ppm.

If the silicon content and the silicon content in solid solution fall within the above ranges, uniformity of electrolytic graining treatment is not impaired, and even when anodizing treatment is carried out after electrolytic graining treatment, defects do not readily occur in the anodized layer, which enables a lithographic printing plate having excellent water retentivity and scumming resistance to be obtained.

In the invention, in terms of further improving the consistency of electrolytic graining treatment, the silicon content in solid solution is preferably in a range of 250 to 500 ppm and more preferably 300 to 480 ppm, and the silicon content is preferably in a range of 0.10 to 0.18 wt % and more preferably 0.11 to 0.15 wt %.

Most of iron does not enter into solid solution in aluminum but remains as intermetallic compounds.

Iron increases the mechanical strength of the aluminum alloy, exerting a large influence on the strength of the lithographic printing plate support. When the iron content is too low, the support will have too low a mechanical strength. As a result, when the lithographic printing plate is mounted onto the plate cylinder of a printing press, the edges thereof may be readily broken. Such breakage readily occur also when a large number of impressions are made at high speed. On the other hand, when the iron content is too high, the support will have a higher strength than necessary. As a result, when mounted onto the plate cylinder of a printing press, the lithographic printing plate may not fit well on the cylinder and the edges thereof may be readily broken during printing. For example, at an iron content exceeding 1.0 wt %, cracking readily occurs during rolling.

The iron content is also known to affect electrolytic graining treatment.

Accordingly, the inventors of the invention focused particular attention on the content in solid solution and found that more excellent consistency is achieved in electrolytic graining treatment by keeping the iron content in solid solution at a predetermined value or less while also keeping the silicon content in solid solution within a specified range when an aluminum alloy plate produced by continuous casting is subjected to electrolytic graining treatment.

In the invention, the iron content is in a range of 0.10 to 0.40 wt % and the iron content in solid solution is in a range of not more than 250 ppm.

If the iron content and the iron content in solid solution fall within the above ranges, the mechanical strength is increased, and breakage of edges of the lithographic printing plate when it is mounted onto the plate cylinder of a printing press and such breakage when a large number of impressions are made at high speed can be prevented from occurring.

If the iron content and the iron content in solid solution fall within the above ranges, the lithographic printing plate will not have a higher strength than necessary. As a result, the lithographic printing plate may fit well on the cylinder when mounted onto the plate cylinder of a printing press, and the edges thereof may be prevented from being broken during printing.

In the invention, in terms of further improving the consistency of electrolytic graining treatment, the iron content in solid solution is preferably in a range of not more than 200 ppm, and the iron content is preferably in a range of 0.12 to 0.39 wt % and more preferably 0.15 to 0.37 wt %.

Copper is an important element for controlling electrolytic graining treatment. Copper enters with great ease into solid solution, although some of the copper forms intermetallic compounds. To achieve an excellent uniformity of electrolytic graining treatment, copper is desirably contained in an amount of at least 0.001 wt %.

Copper contained in an amount in excess of 0.020 wt % will excessively increase the diameter of the pits formed by electrolytic graining treatment in a nitric acid solution while lowering the uniformity of the pit diameter, and thus is especially undesirable from the standpoint of the scumming resistance.

The inventors of the invention have found that by setting the copper content within the above range, pits having a diameter of 0.5 μm or less that are formed by electrolytic graining treatment in a hydrochloric acid solution can be made uniform, and that the surface area of the surface after electrolytic graining treatment can be increased at a maximum rate of increase. A larger rate of increase in the surface area enables the surface area of contact with the image recording layer to be increased, enhancing the bond strength between the support and the image recording layer so that an excellent press life and an excellent cleaner resistance are achieved. Also, a lithographic printing plate manufactured from this support has an excellent scumming resistance.

In the invention, from this point of view, the copper content is preferably in a range of not more than 0.020 wt % and more preferably 0.001 to 0.015 wt %.

The copper content in solid solution is preferably not more than 100 ppm.

To prevent crack formation during casting, the aluminum alloy plate may include, as appropriate, elements which have a crystal grain refining effect. For example, titanium may be included within a range of up to 0.05 wt %, and boron may be included within a range of up to 0.02 wt %.

The balance of the aluminum alloy plate is aluminum and inadvertent impurities. Examples of such impurities include magnesium, manganese, zinc, chromium, zirconium, vanadium, and beryllium. These may be present in respective amounts of up to 0.05 wt %.

Most of the inadvertent impurities will originate from the aluminum ingot. If the inadvertent impurities are what is present in an ingot having an aluminum purity of 99.5 wt %, they will not compromise the intended effects of the invention.

The inadvertent impurities may be, for example, impurities included in the amounts mentioned in Aluminum Alloys: Structure and Properties, by L. F. Mondolfo (1976).

The inventors of the invention found that an aluminum alloy blank containing specified amounts of silicon and iron is treated to obtain a continuously cast and rolled member containing specified amounts of silicon and iron in solid solution, which enables the consistency of electrolytic graining treatment and uniformity of the surface after electrolytic graining treatment to be improved.

The invention is thus capable of obtaining a lithographic printing plate support which is free from appearance defects and has a uniform surface after electrolytic graining treatment and of obtaining a lithographic printing plate having a long press life and an excellent scumming resistance.

At contents in solid solution exceeding their respective upper limits, large pits having a diameter in excess of 10 μm may be readily formed at the electrolytically grained surface, thus leading to reduction in water retentivity, scumming resistance and press life of the resulting lithographic printing plate.

At contents in solid solution of less than their respective lower limits, pits are not fully formed at the electrolytically grained surface, thus leading to significantly visualized slight defects of the aluminum alloy plate (e.g., portion where the aluminum crystal size is not uniform, irregularities), non-uniform appearance of the electrolytically grained surface and reduced press life of the lithographic printing plate.

The inventors of the invention also found that the aluminum alloy plate can contain proper amounts of iron and silicon in solid solution by setting the temperature and time for heat treatment to proper values.

In the practice of the invention, it is preferable to select a specified chemical composition and set the silicon content in solid solution in a specified range with the use of a continuous casting and rolling process in order to obtain an aluminum alloy plate suitable for use as an electrolytically grained support for a lithographic printing plate.

The aluminum alloy plate of the invention is obtained by continuous casting in which an aluminum alloy melt is fed through a melt feed nozzle between a pair of cooling rollers and rolled as it is being solidified by the pair of cooling rollers.

Rolling by means of continuous casting yields fine and uniform crystals because of a large solidification rate of the surface of a cast material, and does not require soaking treatment of an ingot which is necessary in a direct chill casting, or a long-time treatment. The aluminum alloy plate obtained thereby has a consistent quality and is appropriate for use as a blank of a lithographic printing plate support.

To be more specific, the following preferable methods may be used.

First, an aluminum alloy melt that has been adjusted to a given alloying ingredient content is optionally subjected to cleaning treatment by an ordinary method.

Cleaning treatment is carried out, for example, by degassing treatment for removing hydrogen and other unwanted gases from the melt (e.g., flux treatment using argon gas, chlorine gas or the like); filtering treatment using, for example, what is referred to as a rigid media filter (e.g., ceramic tube filter, ceramic foam filter), a filter that employs alumina flakes, alumina balls or the like as the filter medium, or a glass cloth filter; or a combination of degassing treatment and filtering treatment.

It is preferable to carry out cleaning treatment so as to prevent defects due to foreign matter such as nonmetallic inclusions and oxides in the melt, and defects due to dissolved gases in the melt. The filtration of melts is described in, for example, JP 6-57432 A, JP 3-162530 A, JP 5-140659 A, JP 4-231425 A, JP 4-276031 A, JP 5-311261 A, and JP 6-136466 A. The degassing of melts is described in, for example, JP 5-51659 A and JP 5-49148 U. The present applicant proposes a technique concerning the degassing of melts in JP 7-40017 A.

Then, the melt having optionally undergone cleaning treatment is used to carry out continuous casting.

Continuous casting is a step in which an aluminum alloy melt is fed through a melt feed nozzle between a pair of cooling rollers where the aluminum alloy melt is rolled as it is solidified, and is carried out by using processes which use cooling rolls, such as the twin roll process (Hunter process) and the 3C process; and processes which use a cooling belt or a cooling block, such as the twin belt process (Hazelett process) and the Alusuisse Caster II process.

Continuous casting processes generally have a faster cooling rate than direct chill casting processes, and thus are characterized by the ability to achieve a higher solid solubility of alloying ingredients in the aluminum matrix. The melt is solidified at a cooling rate of 100 to 1,000° C./s.

The techniques relating to continuous casting processes that have been proposed by the present applicant are described in, for example, JP 3-79798 A, JP 5-201166 A, JP 5-156414 A, JP 6-262203 A, JP 6-122949 A, JP 6-210406 A and JP 6-26308 A.

When continuous casting is carried out, such as by a process involving the use of cooling rolls (e.g., the Hunter process), the melt can be directly and continuously cast as a plate having a thickness of 1 to 10 mm, thus making it possible to omit the hot rolling step.

Moreover, when use is made of a process that employs a cooling belt (e.g., the Hazelett process), a plate having a thickness of 10 to 50 mm can be cast. Generally, a hot-rolling roll is positioned immediately downstream of a casting machine, and the cast plate is successively rolled, enabling a continuously cast and rolled plate having a thickness of 1 to 10 mm to be obtained.

The aluminum alloy plate obtained as a result of continuous casting is then optionally passed through a step such as cold rolling, and thereby finished to a plate thickness of typically 0.1 to 0.5 mm.

Intermediate annealing may be carried out before or after cold rolling, or even during cold rolling. The intermediate annealing conditions may consist of 2 to 20 hours of heating at 280 to 600° C., and preferably 2 to 10 hours of heating at 350 to 500° C., in a batch-type annealing furnace, or of heating for up to 6 minutes at 400 to 600° C., and preferably up to 2 minutes at 450 to 550° C., in a continuous annealing furnace.

The techniques relating to cold rolling conditions and the intermediate annealing conditions that have been proposed by the present applicant are described in, for example, JP 6-220593 A, JP 6-210308 A, JP 7-54111 A and JP 8-92709 A.

Using a continuous annealing furnace to heat the aluminum alloy plate at a temperature rise rate of 10 to 200° C./s enables a finer crystal structure to be achieved.

The aluminum alloy plate that has been finished by the above steps to a given thickness of, say, 0.1 to 0.5 mm may then be passed through a leveling machine such as a roller leveler or a tension leveler to improve the flatness. The flatness may be improved in this way after the aluminum alloy plate has been cut into discrete sheets. However, to enhance productivity, it is preferable to carry out such flattening with the aluminum alloy in the state of a continuous coil. The plate may also be passed through a slitter line to cut it to a predetermined width.

A thin film of oil may be provided on the aluminum alloy plate surface to prevent scuffing due to rubbing between adjoining aluminum alloy plates. Suitable use may be made of either a volatile or non-volatile oil film, as needed.

It is preferable for the aluminum alloy plate used in the invention to be well-tempered in accordance with H18 defined in JIS. In the case where intermediate annealing is omitted, the aluminum alloy plate is preferably well-tempered in accordance with H19.

In the practice of the invention, intermediate annealing or final cold rolling is preferably followed by heat treatment in terms of easily adjusting the contents in solid solution of alloy elements such as silicon to specified values.

More specifically, in the practice of the invention, the silicon content in solid solution is from 200 to 600 ppm and the iron content in solid solution is up to 250 ppm. Preferably, the copper content in solid solution is up to 100 ppm.

The temperature of heat treatment is preferably at least 300° C., and is preferably not more than 600° C.

The period of heat treatment is preferably at least 5 hours, and is preferably not more than 36 hours.

It is desirable to set the heat treatment conditions taking into account the mechanical strength appropriate for the finally desired plate thickness. It is also desirable to set these conditions taking into account the fact that the larger the distortion given by cold rolling preceding heat treatment is, the more the iron content in solid solution is reduced, for example.

In addition, heat treatment may be carried out in a batch-type heat-treating furnace. In this case, the coil heating rate is up to 100° C./h or less. the retention time varies with the temperature, but is longer at lower temperatures and shorter at higher temperatures.

In the case where heat treatment is not carried out under proper conditions during cold rolling or after final cold rolling, pits formed at the electrolytically grained surface are not uniform in size and water retentivity is impaired to cause ink scumming, thus reducing the press life.

Such a heat treatment enables the silicon, iron and copper contents in solid solution to be set at desired values, so that the aluminum alloy plate for lithographic printing that is capable of obtaining a lithographic printing plate support which is free from appearance defects and has a uniform surface after electrolytic graining treatment can be easily produced.

### <Surface Roughening Treatment>

The lithographic printing plate support of the invention is obtained by subjecting the surface of the aluminum alloy plate obtained by the above-described continuous casting step and various steps carried out as desired (e.g., intermediate annealing step, cold rolling step) to surface roughening treatment.

In general, mechanical graining treatment, chemical graining treatment and electrochemical graining treatment are used for the surface roughening treatment singly or in combination of two or more.

In the practice of the invention, it is preferable for the surface roughening treatment carried out to include at least electrolytic graining treatment and for the electrolytic graining treatment to be preceded by alkali etching treatment (first alkali etching treatment) and followed by alkali etching treatment (second alkali etching treatment).

It is preferable for the surface graining treatment to include two electrochemical graining treatment steps and for etching treatment with an aqueous alkali solution to be carried out therebetween. More specifically, a preferred example is a method in which the aluminum alloy plate is subjected to, in order, etching treatment in an aqueous alkali solution (also referred to below as “first alkali etching treatment”), desmutting treatment in an acidic aqueous solution (also referred to below as “first desmutting treatment”), electrochemical graining treatment in a nitric acid- or hydrochloric acid-containing aqueous solution (also referred to below as “first electrolytic graining treatment”), etching treatment in an aqueous alkali solution (also referred to below as “second alkali etching treatment”), desmutting treatment in an acidic aqueous solution (also referred to below as “second desmutting treatment”), electrochemical graining treatment in a hydrochloric acid-containing aqueous solution (also referred to below as “second electrolytic graining treatment”), etching treatment in an aqueous alkali solution (also referred to below as “third alkali etching treatment”), desmutting treatment in an acidic aqueous solution (also referred to below as “third desmutting treatment”), and anodizing treatment.

The above-described alkali etching treatment (first alkali etching treatment) is preferably preceded by mechanical graining treatment.

It is preferable for sealing treatment and hydrophilizing treatment to be additionally carried out following the above-described anodizing treatment.

The method of producing the lithographic printing plate support of the invention may include various other steps than those described above.

The surface treatment steps are described below in detail.

### <Mechanical Graining Treatment>

In the invention, it is preferable to carry out mechanical graining treatment that is done for the purpose of adjusting the center-line mean surface roughness of the aluminum alloy plate surface in a range of 0.35 to 1.0 μm.

Brush graining that may be advantageously used for mechanical graining treatment is described below.

Brush graining is generally carried out with a roller brush obtained by setting bristles, such as plastic bristles (e.g., bristles made of a plastic such as nylon, polypropylene or polyvinyl chloride), on the surface of a cylindrical roller core. Brush graining is carried out by rubbing one or both sides of the aluminum alloy plate while spraying an abrasive-containing slurry onto the rotating roller brush.

The roller brush and the slurry may be replaced by a polishing roller that is a roller having a polishing layer formed on the surface thereof.

In the case of using the roller brush, the bristles on the brush that may be used have a flexural modulus of preferably 10,000 to 40,000 kgf/cm², and more preferably 15,000 to 35,000 kgf/cm², and have a stiffness of preferably 500 g or less, and more preferably 400 g or less. The bristles generally have a diameter of 0.2 to 0.9 mm. The bristle length may be determined as appropriate depending on the outer diameter of the roller brush and the diameter of the roller core, but the bristles generally have a length of 10 to 100 mm.

In the invention, it is preferable to use a plurality of nylon brushes, more preferably at least three nylon brushes and most preferably at least four nylon brushes. Adjustment of the number of brushes enables the wavelength components of the pits formed at the aluminum alloy plate surface to be adjusted.

The brush rollers are pressed against the aluminum alloy plate until the load on the driving motor that rotates the brushes is preferably 1 kW, more preferably 2 kW and even more preferably 8 kW greater than before the brush rollers are pressed against the plate. Adjustment of the load enables the depth of the pits formed at the aluminum alloy plate surface to be adjusted. The rotation speed of the brushes is preferably at least 100 rpm and more preferably at least 200 rpm.

Use may be made of known abrasives including pumice, silica sand, aluminum hydroxide, alumina powder, silicon carbide, silicon nitride, volcanic ash, carborundum, emery, and a mixture thereof. Of these, pumice and silica sand are preferable. Silica sand is harder and less brittle than pumice and is therefore excellent in graining efficiency. An excessive load may break particles of aluminum hydroxide, so aluminum hydroxide is appropriate in the case where formation of locally deep pits is not desired.

In terms of being excellent in graining efficiency and capable of narrowing the graining pitch, the abrasive preferably has a median diameter of 2 to 100 μm and more preferably 20 to 60 μm. Adjustment of the abrasive median diameter enables the depth of the pits formed at the aluminum alloy plate surface to be adjusted.

The abrasive is suspended in, for example, water to be used as a slurry. In addition to the abrasive, the slurry may include a thickening agent, a dispersant (e.g., a surfactant) and a preservative. The slurry preferably has a specific gravity of 0.5 to 2.

An apparatus as described in JP 50-40047 B is suitable for use in mechanical graining treatment.

The apparatus that may be used in mechanical graining treatment with brushes and an abrasive is mentioned in detail in commonly assigned JP 2002-211159 A.

Another process than brush graining that may be used in mechanical graining treatment is a process in which transfer is carried out at the end of the above-described cold rolling to form irregularities at the plate surface. In the invention, this process may be applied instead of or together with brush graining.

### <First Alkali Etching Treatment>

In the first alkali etching treatment, the aluminum alloy plate is brought into contact with an alkali solution so as to dissolve the surface layer.

The purpose of the first alkali etching treatment carried out prior to electrolytic graining treatment (first electrolytic graining treatment) is to smooth the roughened surface in the case where mechanical graining treatment was carried out, to form uniform pits in electrolytic graining treatment (first electrolytic graining treatment) and to remove substances such as rolling oil, contaminants and a naturally oxidized film from the surface of the aluminum alloy plate.

The amount of material removed in the first alkali etching treatment (also referred to below as the “etching amount”) is preferably at least 0.1 g/m², more preferably at least 0.5 g/m², and even more preferably at least 1 g/m², but preferably not more than 12 g/m², more preferably not more than 10 g/m² and even more preferably not more than 8 g/m². When the lower limit of the etching amount falls within the above range, uniform pits may be formed in electrolytic graining treatment (first electrolytic graining treatment), thus preventing treatment unevenness from occurring. When the upper limit of the etching amount falls within the above range, the amount of aqueous alkali solution used is decreased, which is economically advantageous.

Alkalis that may be used in the alkali solution are exemplified by caustic alkalis and alkali metal salts. Specific examples of suitable caustic alkalis include sodium hydroxide and potassium hydroxide. Specific examples of suitable alkali metal salts include alkali metal silicates such as sodium metasilicate, sodium silicate, potassium metasilicate and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogenphosphates such as disodium hydrogenphosphate, dipotassium hydrogenphosphate, sodium dihydrogenphosphate and potassium dihydrogenphosphate. Of these, caustic alkali solutions and solutions containing both a caustic alkali and an alkali metal aluminate are preferred on account of the high etch rate and low cost. An aqueous solution of sodium hydroxide is especially preferred.

In the first alkali etching treatment, the alkali solution has a concentration of preferably at least 30 g/L, and more preferably at least 300 g/L, but preferably not more than 500 g/L, and more preferably not more than 450 g/L.

It is desirable for the alkali solution to contain aluminum ions. The aluminum ion concentration is preferably at least 1 g/L, and more preferably at least 50 g/L, but preferably not more than 200 g/L, and more preferably not more than 150 g/L. Such an alkali solution can be prepared using, for example, water, a 48 wt % aqueous sodium hydroxide solution, and sodium aluminate.

In the first alkali etching treatment, the alkali solution has a temperature of preferably at least 30° C., and more preferably at least 50° C., but preferably not more than 80° C., and more preferably not more than 75° C.

In the first alkali etching treatment, the treatment time is preferably at least 1 second, and more preferably at least 2 seconds, but preferably not more than 30 seconds, and more preferably not more than 15 seconds.

When the aluminum alloy plate is continuously etched, the aluminum ion concentration in the alkali solution rises and the amount of material etched from the aluminum alloy plate changes. It is thus desirable to control the etching solution composition as follows.

First, a matrix of the electrical conductivity, specific gravity and temperature or a matrix of the conductivity, ultrasonic wave propagation velocity and temperature is prepared with respect to a matrix of the sodium hydroxide concentration and the aluminum ion concentration. The solution composition is then measured based on either the conductivity, specific gravity and temperature or the conductivity, ultrasonic wave propagation velocity and temperature, and sodium hydroxide and water are added up to control target values for the solution composition. Next, the etching solution which has increased in volume with the addition of sodium hydroxide and water is allowed to overflow from a circulation tank, thereby keeping the amount of solution constant. The sodium hydroxide added may be industrial-grade 40 to 60 wt % sodium hydroxide.

The conductivity meter and hydrometer used are preferably temperature-compensated instruments. The hydrometer is preferably a pressure differential hydrometer.

Illustrative examples of methods for bringing the aluminum alloy plate into contact with the alkali solution include passing the aluminum alloy plate through a tank filled with the alkali solution, immersing the aluminum alloy plate in a tank filled with the alkali solution, and spraying the surface of the aluminum alloy plate with the alkali solution.

The most desirable of these is a method that involves spraying the surface of the aluminum alloy plate with the alkali solution. A method in which the etching solution is sprayed from at least one spray line, and preferably two or more spray lines, each having 2 to 5 mm diameter openings spaced at a pitch of 10 to 50 mm, at a rate of 10 to 100 L/min per spray line is desirable.

Following completion of the first alkali etching treatment, it is desirable to remove etching solution remaining on the aluminum alloy plate with nip rollers, subject the plate to rinsing treatment with water for 1 to 10 seconds, then remove the water with nip rollers.

Rinsing treatment is preferably carried out by rinsing with a rinsing apparatus that uses a free-falling curtain of water and also by rinsing with spray lines.

An apparatus that carries out rinsing treatment with a free-falling curtain of water has a water holding tank that holds water, a pipe that feeds water to the water holding tank, and a flow distributor that supplies a free-falling curtain of water from the water holding tank to an aluminum alloy plate.

In this apparatus, the pipe feeds water to the water holding tank. When the water in the tank overflows, it is distributed by the flow distributor and a free-falling curtain of water is supplied to the aluminum alloy plate. During the use of this apparatus, the flow rate is preferably 10 to 100 L/min. The distance over which the water between the flow distributor and the aluminum alloy plate exists as a free-falling curtain of liquid is preferably from 20 to 50 mm. Moreover, it is preferable for the aluminum alloy plate to be inclined at an angle to the horizontal of 30 to 80°.

By using the apparatus which rinses the aluminum alloy plate with a free-falling curtain of water, the aluminum alloy plate can be uniformly rinsed. This makes it possible to enhance the uniformity of the treatment carried out prior to rinsing. A suitable example of an apparatus that carries out rinsing treatment with a free-falling curtain of water is described in JP 2003-96584 A.

Alternatively, rinsing may be carried out with a spray line having a plurality of spray tips that discharge fan-like sprays of water and are disposed along the width of the aluminum alloy plate. The interval between the spray tips is preferably 20 to 100 mm, and the amount of water discharged per spray tip is preferably 0.5 to 20 L/min. The use of a plurality of spray lines is preferred.

### <First Desmutting Treatment>

After the first alkali etching treatment, it is preferable to carry out acid pickling (first desmutting treatment) to remove contaminants (smut) remaining on the surface of the aluminum alloy plate. Desmutting treatment is carried out by bringing an acidic solution into contact with the aluminum alloy plate.

Examples of acids that may be used include nitric acid, sulfuric acid, phosphoric acid, chromic acid, hydrofluoric acid and tetrafluoroboric acid.

In the first desmutting treatment which follows the first alkali etching treatment, it is preferable to use overflow from the electrolytic solution employed in electrolysis using nitric acid when it is subsequently carried out as electrolytic graining treatment (first electrolytic graining treatment).

The composition of the desmutting treatment solution can be controlled by selecting and using a method of control based on electrical conductivity and temperature with respect to a matrix of the acidic solution concentration and the aluminum ion concentration, a method of control based on electrical conductivity, specific gravity and temperature with respect to the above matrix, or a method of control based on electrical conductivity, ultrasonic wave propagation velocity and temperature with respect to the above matrix.

In the first desmutting treatment, it is preferable to use an acidic solution containing 1 to 400 g/L of acid and 0.1 to 5 g/L of aluminum ions.

The acidic solution has a temperature of preferably at least 20° C., and more preferably at least 30° C., but preferably not more than 70° C., and more preferably not more than 60° C.

In the first desmutting treatment, the treatment time is preferably at least 1 second, and more preferably at least 4 seconds, but preferably not more than 60 seconds, and more preferably not more than 40 seconds.

Illustrative examples of the method of bringing the aluminum alloy plate into contact with the acidic solution include passing the aluminum alloy plate through a tank filled with the acidic solution, immersing the aluminum alloy plate in a tank filled with the acidic solution, and spraying the acidic solution onto the surface of the aluminum alloy plate.

Of these, a method in which the acidic solution is sprayed onto the surface of the aluminum alloy plate is preferred. More specifically, a method in which a desmutting solution is sprayed from at least one spray line, and preferably two or more spray lines, each having 2 to 5 mm diameter openings spaced at a pitch of 10 to 50 mm, at a rate of 10 to 100 L/min per spray line is desirable.

After desmutting treatment, it is preferable to remove solution remaining on the plate with nip rollers, then to carry out rinsing treatment with water for 1 to 10 seconds and remove the water from the plate with nip rollers.

Rinsing treatment here is the same as rinsing treatment following alkali etching treatment. However, it is preferable for the amount of water discharged per spray tip to be from 1 to 20 L/min.

If overflow from the electrolytic solution used in the subsequently carried out electrolysis with nitric acid is employed as the desmutting solution in the first desmutting treatment, rather than having desmutting treatment followed by the removal of solution with nip rollers and rinsing treatment, it is preferable to handle the aluminum alloy plate up until the electrolysis step using nitric acid by suitably spraying it with the desmutting solution as needed so that the surface of the aluminum alloy plate does not dry.

### <First Electrolytic Graining Treatment>

The first electrolytic graining treatment is an electrolytic graining treatment carried out in a nitric acid- or hydrochloric acid-containing aqueous solution.

In order to increase the latitude of the electrolytically grained surface, the first electrolytic graining treatment of the invention is preferably a treatment which uses an alternating current having a trapezoidal waveform in a nitric acid-containing electrolytic solution. In order to easily control the shape of the electrolytically grained surface, the first electrolytic graining treatment is preferably a treatment which uses an alternating current having a sinusoidal waveform in a hydrochloric acid-containing electrolytic solution.

The aluminum alloy plate having undergone the first electrolytic graining treatment preferably has a mean surface roughness Rₐ of 0.2 to 1.0 μm.

### (Electrolytic Graining Treatment in Nitric Acid-Containing Aqueous Solution (Nitric Acid Electrolysis))

Nitric acid electrolysis enables an appropriately roughened structure to be formed at the surface of the aluminum alloy plate. If the aluminum alloy plate has a relatively high copper content in the invention, nitric acid electrolysis forms relatively large and uniform recesses at the surface of the aluminum alloy plate. As a result, a lithographic printing plate manufactured using the lithographic printing plate support obtained from the above aluminum alloy plate has a long press life.

Any nitric acid-containing aqueous solution which is used in conventional electrochemical graining involving the use of direct current or alternating current may be employed. The nitric acid-containing aqueous solution may be prepared by adding to an aqueous solution having a nitric acid concentration of 1 to 100 g/L at least one nitrate compound containing nitrate ions, such as aluminum nitrate, sodium nitrate or ammonium nitrate, in a range of 1 g/L to saturation.

Metals which are present in the aluminum alloy, such as iron, copper, manganese, nickel, titanium, magnesium and silicon may also be dissolved in the nitric acid-containing aqueous solution. Hypochlorous acid or hydrogen peroxide may be added in an amount of 1 to 100 g/L.

More specifically, it is preferred to use a solution which has an aluminum ion concentration adjusted to 3 to 7 g/L by dissolving aluminum nitrate in an aqueous nitric acid solution having a nitric acid concentration of 5 to 15 g/L.

The nitric acid-containing aqueous solution preferably has a temperature of 20° C. to 55° C.

Nitric acid electrolysis enables pits having an average opening diameter of 1 to 10 μm to be formed. However, a relatively increased amount of electricity causes concentration of an electrolytic reaction, leading to formation of honeycomb pits having an opening diameter in excess of 10 μm as well.

To obtain such a grained surface, the total amount of electricity furnished for the anodic reaction on the aluminum alloy plate up until completion of the electrolytic reaction is preferably at least 150 C/dm², and more preferably at least 170 C/dm², but preferably not more than 600 C/dm², and more preferably not more than 500 C/dm².

The peak current density at this time is preferably at least 5 A/dm² and more preferably from 20 to 100 A/dm².

### (Electrolytic Graining Treatment in Hydrochloric Acid-Containing Aqueous Solution (First Hydrochloric Acid Electrolysis))

Any hydrochloric acid-containing aqueous solution which is used in conventional electrochemical graining involving the use of direct current or alternating current may be employed. The hydrochloric acid-containing aqueous solution may be prepared by adding to an aqueous solution having a hydrochloric acid concentration of 1 to 30 g/L and preferably 2 to 10 g/L at least one nitrate compound containing nitrate ions, such as aluminum nitrate, sodium nitrate or ammonium nitrate, or at least one chloride compound containing chloride ions, such as aluminum chloride, sodium chloride or ammonium chloride in a range of 1 g/L to saturation.

Metals which are present in the aluminum alloy, such as iron, copper, manganese, nickel, titanium, magnesium and silicon may also be dissolved in the hydrochloric acid-containing aqueous solution. Hypochlorous acid or hydrogen peroxide may be added in an amount of 1 to 100 g/L. A compound which forms a complex with copper may also be added in an amount of 1 to 200 g/L.

The hydrochloric acid-containing aqueous solution that may be particularly preferred is an aqueous solution prepared by adding an aluminum salt (aluminum chloride: AlCl₃.6H₂O) to an aqueous solution containing 2 to 10 g/L of hydrochloric acid to adjust the aluminum ion concentration to 3 to 7 g/L and preferably 4 to 6 g/L.

Electrolytic graining treatment using such an aqueous hydrochloric acid solution makes the electrolytically grained surface more uniform, and no treatment unevenness occurs irrespective of whether a low-purity or a high-purity aluminum alloy plate is used. As a result, the lithographic printing plate obtained by using such an aluminum alloy plate can have a longer press life and a more excellent scumming resistance.

The hydrochloric acid-containing aqueous solution has a temperature of preferably at least 20° C. and more preferably at least 30° C., but preferably not more than 55° C. and more preferably not more than 50° C.

Conditions used in known electrochemical graining treatment may be employed for the substances added to the hydrochloric acid-containing aqueous solution, apparatus, power supply, current density, flow rate and temperature. In electrochemical graining, an AC power supply or a DC power supply is used, but an AC power supply is particularly preferred.

Because hydrochloric acid itself has a strong ability to dissolve aluminum, fine irregularities can be formed on the surface by slightly carrying out electrolysis. These fine irregularities have an average opening diameter (pit diameter) of 0.01 to 1.5 μm, and are uniformly formed over the entire surface of the aluminum alloy plate.

By increasing the amount of electricity (to a total amount of electricity furnished for the anodic reaction of 150 to 2000 C/dm²), large pits with an average opening diameter of 1 to 30 μm are produced which have small pits with an average opening diameter of 0.01 to 0.4 μm formed on the surfaces thereof. To obtain such a grained surface, the total amount of electricity furnished for the anodic reaction on the aluminum alloy plate up until completion of the electrolytic reaction is preferably at least 10 C/dm², more preferably at least 50 C/dm², and even more preferably at least 100 C/dm², but preferably not more than 2000 C/dm², and more preferably not more than 600 C/dm².

In hydrochloric acid electrolysis, the peak current density is preferably at least 5 A/dm² and more preferably from 20 to 100 A/dm².

Hydrochloric acid electrolysis of the aluminum alloy plate with a large amount of electricity enables large undulations and fine irregularities to be formed at a time. Scumming resistance can be improved by making uniform the large undulations in the second alkali etching treatment to be described later.

The first electrolytic graining treatment may be carried out in accordance with the electrochemical graining processes (electrolytic graining processes) described in, for example, JP 48-28123 B and GB 896,563 B. These electrolytic graining processes use an alternating current having a sinusoidal waveform, although they may also be carried out using special waveforms like those described in JP 52-58602 A. Use can also be made of the waveforms described in JP 3-79799 A. Other processes that may be employed for this purpose include those described in JP 55-158298 A, JP 56-28898 A, JP 52-58602 A, JP 52-152302 A, JP 54-85802 A, JP 60-190392 A, JP 58-120531 A, JP 63-176187 A, JP 1-5889 A, JP 1-280590 A, JP 1-118489 A, JP 1-148592 A, JP 1-178496 A, JP 1-188315 A, JP 1-154797 A, JP 2-235794 A, JP 3-260100 A, JP 3-253600 A, JP 4-72079 A, JP 4-72098 A, JP 3-267400 A and JP 1-141094 A. In addition to the above, electrolysis can also be carried out using alternating currents of a special frequency such as have been proposed in connection with methods for manufacturing electrolytic capacitors. These are described in, for example, U.S. Pat. No. 4,276,129 and U.S. Pat. No. 4,676,879.

Various electrolytic cells and power supplies have been proposed for use in the first electrolytic graining treatment. Use may be made of those described in, for example, U.S. Pat. No. 4,203,637, JP 56-123400 A, JP 57-59770 A, JP 53-12738 A, JP 53-32821 A, JP 53-32822 A, JP 53-32823 A, JP 55-122896 A, JP 55-132884 A, JP 62-127500 A, JP 1-52100 A, JP 1-52098 A, JP 60-67700 A, JP 1-230800 A, JP 3-257199 A, JP 52-58602 A, JP 52-152302 A, JP 53-12738 A, JP 53-12739 A, JP 53-32821 A, JP 53-32822 A, JP 53-32833 A, JP 53-32824 A, JP 53-32825 A, JP 54-85802 A, JP 55-122896 A, JP 55-132884 A, JP 48-28123 B, JP 51-7081 B, JP 52-133838 A, JP 52-133840 A, JP 52-133844 A, JP 52-133845 A, JP 53-149135 A and JP 54-146234 A.

When electrolytic graining treatment is continuously carried out on the aluminum alloy plate, the aluminum ion concentration in the alkali solution rises over time, as a result of which the shape of the irregularities formed on the aluminum alloy plate by the first electrolytic graining treatment will fluctuate. It is thus advantageous to control the composition of the nitric acid- or hydrochloric acid-containing electrolytic solution as follows.

First, a matrix of the electrical conductivity, specific gravity and temperature or a matrix of the conductivity, ultrasonic wave propagation velocity and temperature is prepared with respect to a matrix of the nitric acid or hydrochloric acid concentration and the aluminum ion concentration. The solution composition is then measured based on either the conductivity, specific gravity and temperature or the conductivity, ultrasonic wave propagation velocity and temperature, and nitric acid or hydrochloric acid and water are added to the solution up to control target values for the solution composition. Next, the electrolytic solution which has increased in volume with the addition of nitric acid or hydrochloric acid and water is allowed to overflow from a circulation tank, thereby holding the amount of solution constant. The nitric acid added may be industrial-grade 30 to 70 wt % nitric acid. The hydrochloric acid added may be industrial-grade 30 to 40 wt % hydrochloric acid.

The conductivity meter and hydrometer used are preferably temperature-compensated instruments. The hydrometer is preferably a pressure differential hydrometer.

To measure the solution composition to a high accuracy, it is preferable that samples collected from the electrolytic solution for the purpose of measurement of the solution composition be furnished for measurement after first being controlled to a fixed temperature (e.g., 40±0.5° C.) using a different heat exchanger from the one used for the electrolytic solution.

No particular limitation is imposed on the waveform of the alternating current used in electrochemical graining treatment. For example, a sinusoidal, square, trapezoidal or triangular waveform may be used. Of these, a sinusoidal, square or trapezoidal waveform is preferred. A trapezoidal waveform is especially preferred. A sinusoidal waveform is especially preferred in the case of the first hydrochloric acid electrolysis, because pits having an average diameter of at least 1 μm are uniformly and readily produced. “Sinusoidal waveform” refers herein to a waveform like that shown in FIG. 4.

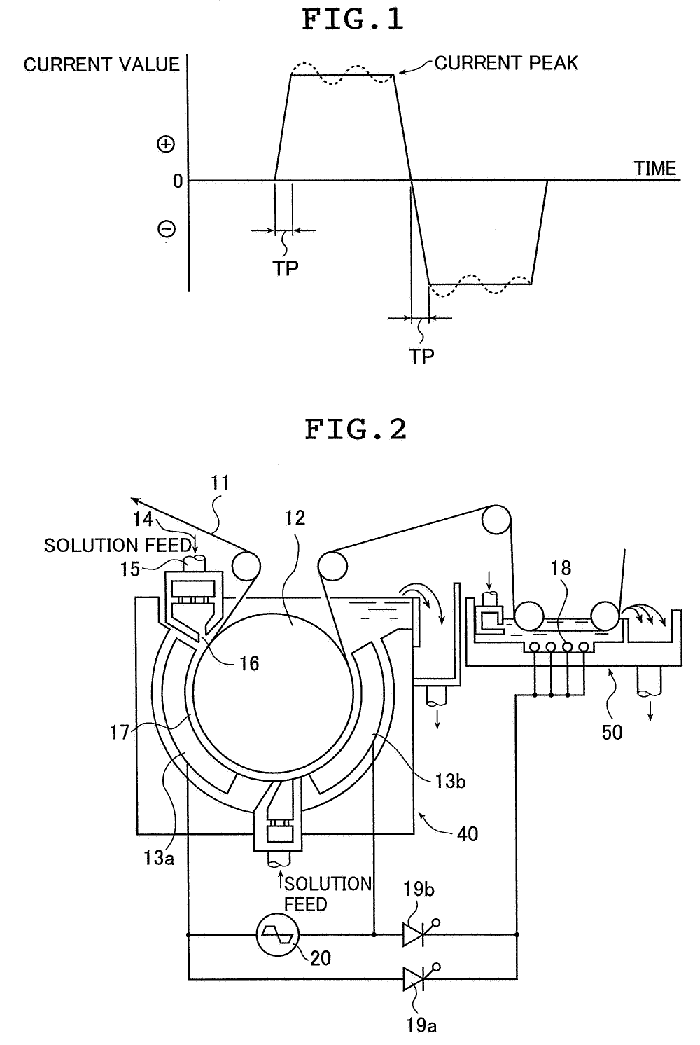

“Trapezoidal waveform” refers herein to a waveform like that shown in FIG. 1. In this trapezoidal waveform, it is preferable for the time TP until the current reaches a peak from zero to be from 0.5 to 3.0 ms. At a TP of more than 3 ms, particularly when a nitric acid-containing aqueous solution is used, the aluminum alloy plate tends to be affected by ammonium ions and other trace ingredients in the electrolytic solution that spontaneously increase during electrolytic treatment, making it difficult to carry out uniform graining. As a result, there is a tendency for lithographic printing plates obtained using the aluminum alloy plate to have a diminished scumming resistance.

Use can be made of an alternating current having a duty ratio of from 1:2 to 2:1. However, as noted in JP 5-195300 A, use of an alternating current having a duty ratio of 1:1 is preferred in an indirect power feed system that does not use a conductor roll to feed current to the aluminum alloy plate.

Use can be made of an alternating current having a frequency of from 0.1 to 120 Hz, although a frequency of 50 to 70 Hz is preferable from the standpoint of the equipment. At a frequency lower than 50 Hz, the carbon electrode serving as the main electrode tends to dissolve more readily. On the other hand, at a frequency higher than 70 Hz, the power supply circuit is more readily subject to the influence of inductance components thereon, increasing the power supply costs.

FIG. 2 is a side view of a radial electrolytic cell that may be used in electrochemical graining treatment with alternating current in a method of manufacturing the lithographic printing plate support of the invention.

One or more AC power supplies may be connected to the electrolytic cell. To control the anode/cathode current ratio of the alternating current applied to the aluminum alloy plate facing the main electrodes and thereby carry out uniform graining and to dissolve carbon from the main electrodes, it is advantageous to provide an auxiliary anode and divert some of the alternating current as shown in FIG. 2. FIG. 2 shows an aluminum alloy plate 11, a radial drum roller 12, main electrodes 13a and 13b, an electrolytic treatment solution 14, a solution feed inlet 15, a slit 16, a solution channel 17, an auxiliary anode 18, thyristors 19a and 19b, an AC power supply 20, a main electrolytic cell 40 and an auxiliary anode cell 50. By using a rectifying or switching device to divert some of the current as direct current to an auxiliary anode provided in a separate cell from that containing the two main electrodes, it is possible to control the ratio between the current furnished for the anodic reaction which acts on the aluminum alloy plate facing the main electrodes and the current furnished for the cathodic reaction. The ratio between the amount of electricity furnished for the anodic reaction and that furnished for the cathodic reaction on the aluminum alloy plate facing the main electrodes (the ratio between the total amount of electricity when the aluminum alloy plate serves as a cathode and that when the aluminum alloy plate serves as an anode) is preferably in a range of 0.3 to 0.95.

Any known electrolytic cell employed for surface treatment, including vertical, flat and radial type electrolytic cells, may be used to carry out the first electrolytic graining treatment. Radial-type electrolytic cells such as those described in JP 5-195300 A are especially preferred. The electrolytic solution is passed through the electrolytic cell either parallel or counter to the direction in which the aluminum alloy plate (aluminum web) advances.

Electrolytic solution used in conventional electrochemical graining treatment with a direct current may be used for the electrochemical graining treatment with a direct current. More specifically, electrolytes of the same type as those used in the above-described electrochemical graining treatment with an alternating current may be used.

The direct current used in electrochemical graining treatment is not particularly limited as long as the polarity of the current used does not change. Examples that may be used include a DC having a comb-shaped waveform, a continuous DC and a current obtained by fully rectifying a commercial AC with a thyristor, and a smoothed continuous DC is preferably used.

Electrochemical graining treatment with a direct current may be carried out by any of a batch process, a semicontinuous process, and a continuous process, but a continuous process is preferably used.

The apparatus used for electrochemical graining treatment with a direct current is not particularly limited, as long as the apparatus is configured to apply a dc voltage across anodes and cathodes disposed alternately and to allow an aluminum alloy plate to pass between the anodes and cathodes in pairs while keeping the distance therebetween.

The electrodes are not particularly limited but conventionally known electrodes employed in electrochemical graining treatment may be used.

Examples of the anode that may be preferably used include ones formed by plating or cladding valve metals such as titanium, tantalum and niobium with platinum-group metals; ones formed by coating or sintering platinum-group metal oxides on the valve metals; aluminum; and stainless steel. Of these, ones formed by cladding the valve metals with platinum are preferably used. The anode can have a further extended service life, for example, by a method in which the electrode is cooled by passing water inside the electrode.

Metals that do not dissolve at a negative electrode potential may be selected and used for the cathode based on Pourbaix diagrams. Carbon is particularly preferable.

The arrangement of the electrodes may be selected as appropriate for the wavy structure. The wavy structure may be adjusted by changing the length of the anode and the cathode in the direction of travel of the aluminum alloy plate, passing speed of the aluminum alloy plate, flow rate, temperature and composition of the electrolytic solution, and current density. In the case of using an apparatus including separate electrolytic cells for the anode and cathode, the electrolysis conditions in the respective cells may also be changed.

Following completion of the first electrolytic graining treatment, it is desirable to remove the electrolytic solution remaining on the aluminum alloy plate with nip rollers, subject the plate to rinsing treatment with water for 1 to 10 seconds, then remove the water with nip rollers.

Rinsing treatment is preferably carried out with a spray line. Use may be made of a spray line having a plurality of spray tips that discharge fan-like sprays of water and are disposed along the width of the aluminum alloy plate. The interval between the spray tips is preferably 20 to 100 mm, and the amount of water discharged per spray tip is preferably 1 to 20 L/min. The use of a plurality of spray lines is preferred.

### <Second Alkali Etching Treatment>

The purpose of the second alkali etching treatment carried out between the first electrolytic graining treatment and the second electrolytic graining treatment is to dissolve the smut that arises in the first electrolytic graining treatment and to dissolve the edges of the pits formed by the first electrolytic graining treatment.

The second alkali etching treatment causes the edges of the large pits formed by the first electrolytic graining treatment to dissolve to smooth the plate surface, and as a result, ink does not readily catch on the edges. Therefore, a lithographic printing plate having an excellent scumming resistance can be obtained.

Because the second alkali etching treatment is basically the same as the first alkali etching treatment, only those features that differ are described below.

The amount of material removed from the aluminum alloy plate in the second alkali etching treatment is preferably at least 0.05 g/m², and more preferably at least 0.1 g/m², but preferably not more than 4 g/m², and more preferably not more than 3.5 g/m². At an etching amount of 0.05 g/m² or more, the edges of the pits formed in the first electrolytic graining treatment are smoothed and ink does not readily catch on the edges of the pits, thus enhancing the scumming resistance in non-image areas of the lithographic printing plate. At an etching amount of not more than 4 g/m², the irregularities formed in the first electrolytic graining treatment become larger, thus achieving a long press life.

In the second alkali etching treatment, the alkali solution has a concentration of preferably at least 30 g/L, and more preferably at least 300 g/L, but preferably not more than 500 g/L, and more preferably not more than 450 g/L.

It is advantageous for the alkali solution to contain aluminum ions. The aluminum ion concentration is preferably at least 1 g/L, and more preferably at least 50 g/L, but preferably not more than 200 g/L, and more preferably not more than 150 g/L. Such an alkali solution can be prepared using water, a 48 wt % aqueous sodium hydroxide solution, and sodium aluminate.

### <Second Desmutting Treatment>

After the second alkali etching treatment, it is preferable to carry out acid pickling (second desmutting treatment) to remove smut remaining on the surface of the aluminum alloy plate. The second desmutting treatment can be carried out in the same manner as the first desmutting treatment.

In the second desmutting treatment, it is preferable to use nitric acid or sulfuric acid.

The second desmutting treatment is preferably carried out using an acidic solution containing 1 to 400 g/L of acid and 0.1 to 8 g/L of aluminum ions.

In the case of using sulfuric acid, more specifically, use may be made of a solution prepared by dissolving aluminum sulfate in an aqueous sulfuric acid solution having a sulfuric acid concentration of 100 to 350 g/L so as to have an aluminum ion concentration of 0.1 to 5 g/L. Use may also be made of overflow from the electrolytic solution used in anodizing treatment to be described later.

In the second desmutting treatment, the treatment time is preferably at least 1 second, and more preferably at least 4 seconds, but preferably not more than 60 seconds, and more preferably not more than 20 seconds.

In the second desmutting treatment, the aqueous acid solution has a temperature of at least 20° C., and more preferably at least 30° C., but preferably not more than 70° C., and more preferably not more than 60° C.

### <Second Electrolytic Graining Treatment (Second Hydrochloric Acid Electrolysis)>

The second electrolytic graining treatment is an electrochemical graining treatment carried out in a hydrochloric acid-containing aqueous solution with an alternating current or a direct current.

The above-described first electrolytic graining treatment may only be carried out in the invention. However, the combination with the second electrolytic graining treatment enables a more complex topographic structure to be formed at the aluminum alloy plate surface, thus achieving a long press life.

The second electrolytic graining treatment is basically the same as the first hydrochloric acid electrolysis described in connection with the first electrolytic graining treatment.

The total amount of electricity furnished for the anodic reaction on the aluminum alloy plate through electrochemical graining in a hydrochloric acid-containing aqueous solution in the second electrolytic graining treatment may be selected from a range of 10 to 200 C/dm² at the time electrochemical graining treatment has been finished. In order to substantially keep the surface roughened by the first electrolytic graining treatment, the total amount of electricity is preferably from 10 to 100 C/dm², and more preferably from 50 to 80 C/dm².

### <First Alkali Etching Treatment—First Electrolytic Graining Treatment (Nitric Acid Electrolysis)—Second Alkali Etching Treatment—Second Electrolytic Treatment (Second Hydrochloric Acid Electrolysis)>

In the case where the above treatments are carried out in combination, nitric acid electrolysis in which the total amount of electricity in the anodic reaction carried out in the nitric acid-containing electrolytic solution is from 65 to 500 C/dm², alkali etching treatment in which at least 0.1 g/m² of material is dissolved out, the second hydrochloric acid electrolysis in which the total amount of electricity in the anodic reaction carried out in the hydrochloric acid-containing electrolytic solution is from 25 to 100 C/dm², and alkali etching treatment in which at least 0.03 g/m² of material is dissolved out are preferably carried out in this order.

A lithographic printing plate support capable of obtaining a lithographic printing plate having a longer press life and a more excellent scumming resistance can be obtained by carrying out the surface roughening treatment based on the above combination.

### <Third Alkali Etching Treatment>

The purpose of the third alkali etching treatment carried out after the second electrolytic graining treatment is to dissolve the smut that arises in the second electrolytic graining treatment, and to dissolve the edges of the pits formed by the second electrolytic graining treatment. Because the third alkali etching treatment is basically the same as the first alkali etching treatment, only the features that differ are described below.

The amount of material removed by the third alkali etching treatment is preferably at least 0.05 g/m², and more preferably at least 0.1 g/m², but preferably not more than 0.3 g/m², and more preferably not more than 0.25 g/m². At an etching amount of 0.05 g/m² or more, the edges of the pits formed in the second hydrochloric acid electrolysis are smoothed and ink does not readily catch on the edges of the pits, thus enhancing the scumming resistance in non-image areas of the lithographic printing plate. At an etching amount of not more than 0.3 g/m², the irregularities formed in the first and second electrolytic graining treatments become larger, thus achieving a long press life.

In the third alkali etching treatment, the alkali solution has a concentration of preferably at least 30 g/L. However, to keep the irregularities formed in the preceding hydrochloric acid electrolysis with an alternating current from becoming too small, the concentration is preferably not more than 100 g/L, and more preferably not more than 70 g/L.

It is advantageous for the alkali solution to contain aluminum ions. The aluminum ion concentration is preferably at least 1 g/L, and more preferably at least 3 g/L, but preferably not more than 50 g/L, and more preferably not more than 8 g/L. Such an alkali solution can be prepared using water, a 48 wt % aqueous sodium hydroxide solution, and sodium aluminate.

In the third alkali etching treatment, the alkali solution has a temperature of preferably at least 25° C., and more preferably at least 30° C., but preferably not more than 60° C., and more preferably not more than 50° C.

In the third alkali etching treatment, the treatment time is preferably at least 1 second, and more preferably at least 2 seconds, but preferably not more than 30 seconds, and more preferably not more than 10 seconds.

### <Third Desmutting Treatment>

After the third alkali etching treatment, it is preferable to carry out acid pickling (third desmutting treatment) to remove smut remaining on the surface of the aluminum alloy plate. Because the third desmutting treatment is basically the same as the first desmutting treatment, only the features that differ are described below.

In the third desmutting treatment, it is preferable to use an acidic solution containing 5 to 400 g/L of acid and 0.5 to 8 g/L of aluminum ions. In the case of using sulfuric acid, more specifically, it is preferred to use a solution which has an aluminum ion concentration adjusted to 1 to 5 g/L by dissolving aluminum sulfate in an aqueous sulfuric acid solution having a sulfuric acid concentration of 100 to 350 g/L.

In the third desmutting treatment, the treatment time is preferably at least 1 second, and more preferably at least 4 seconds, but preferably not more than 60 seconds, and more preferably not more than 15 seconds.

When the desmutting solution used in the third desmutting treatment is a solution of the same type as the electrolytic solution employed in the subsequently carried out anodizing treatment, solution removal with nip rollers and rinsing that are to be carried out after the third desmutting treatment may be omitted.

### <Anodizing Treatment>

Preferably, the aluminum alloy plate treated as described above is also subjected to anodizing treatment. Anodizing treatment may be carried out by any method commonly used in the art. More specifically, an anodized layer can be formed on the surface of the aluminum alloy plate by passing a current through the aluminum alloy plate as the anode in, for example, a solution having a sulfuric acid concentration of 50 to 300 g/L and an aluminum ion concentration of up to 5 wt %. Acids such as sulfuric acid, phosphoric acid, chromic acid, oxalic acid, sulfamic acid, benzenesulfonic acid and amidosulfonic acid may be used singly or in combination of two or more for the solution for use in anodizing treatment.

It is acceptable for at least ingredients ordinarily present in the aluminum alloy plate, electrodes, tap water, ground water and the like to be present in the electrolytic solution. In addition, secondary and tertiary ingredients may be added. Here, “second and tertiary ingredients” includes, for example, the ions of metals such as sodium, potassium, magnesium, lithium, calcium, titanium, aluminum, vanadium, chromium, manganese, iron, cobalt, nickel, copper and zinc; cations such as ammonium ions; and anions such as nitrate ions, carbonate ions, chloride ions, phosphate ions, fluoride ions, sulfite ions, titanate ions, silicate ions and borate ions. These may be present in concentrations of about 0 to 10,000 ppm.

The anodizing treatment conditions vary empirically according to the electrolytic solution used, although it is generally suitable for the solution to have an electrolyte concentration of 1 to 80 wt % and a temperature of 5 to 70° C., and for the current density to be 0.5 to 60 A/dm², the voltage to be 1 to 100 V, and the electrolysis time to be 15 seconds to 50 minutes. These conditions may be adjusted to obtain the desired anodized layer weight.

Methods that may be used to carry out anodizing treatment include those described in JP 54-81133 A, JP 57-47894 A, JP 57-51289 A, JP 57-51290 A, JP 57-54300 A, JP 57-136596 A, JP 58-107498 A, JP 60-200256 A, JP 62-136596 A, JP 63-176494 A, JP 4-176897 A, JP 4-280997 A, JP 6-207299 A, JP 5-24377 A, JP 5-32083 A, JP 5-125597 A and JP 5-195291 A.

Of these, as described in JP 54-12853 A and JP 48-45303 A, it is preferable to use a sulfuric acid solution as the electrolytic solution. The electrolytic solution has a sulfuric acid concentration of preferably 10 to 300 g/L (1 to 30 wt %), and more preferably 50 to 200 g/L (5 to 20 wt %), and has an aluminum ion concentration of preferably 1 to 25 g/L (0.1 to 2.5 wt %), and more preferably 2 to 10 g/L (0.2 to 1 wt %). Such an electrolytic solution can be prepared by adding a compound such as aluminum sulfate to dilute sulfuric acid having a sulfuric acid concentration of 50 to 200 g/L.

Control of the electrolytic solution composition is typically carried out using a method similar to that employed in the above-described nitric acid electrolysis. That is, control is preferably effected by means of the electrical conductivity, specific gravity and temperature or of the conductivity, ultrasonic wave propagation velocity and temperature with respect to a matrix of the sulfuric acid concentration and the aluminum ion concentration.

The electrolytic solution has a temperature of preferably 25 to 55° C., and more preferably 30 to 50° C.

When anodizing treatment is carried out in an electrolytic solution containing sulfuric acid, direct current or alternating current may be applied across the aluminum alloy plate and the counter electrode.

When a direct current is applied to the aluminum alloy plate, the current density is preferably 1 to 60 A/dm², and more preferably 5 to 40 A/dm².

To keep burnt deposits (areas of the anodized layer which are thicker than surrounding areas) from arising on portions of the aluminum alloy plate due to the concentration of current when anodizing treatment is carried out as a continuous process, it is preferable to apply current at a low density of 5 to 10 A/m² at the start of anodizing treatment and to increase the current density to 30 to 50 A/dm² or more as anodizing treatment proceeds.

Specifically, it is preferable for current from the DC power supplies to be allocated such that current from downstream DC power supplies is equal to or greater than current from upstream DC power supplies. Current allocation in this way will discourage the formation of burnt deposits, enabling high-speed anodization to be carried out.

When anodizing treatment is carried out as a continuous process, this is preferably done using a system that supplies power to the aluminum alloy plate through the electrolytic solution.

By carrying out anodizing treatment under such conditions, a porous film having numerous pores (micropores) can be obtained. These micropores generally have an average diameter of about 5 to 50 nm and an average pore density of about 300 to 800 pores/μm².

The weight of the anodized layer is preferably 1 to 5 g/m². At less than 1 g/m², scratches are readily formed on the plate. On the other hand, a weight of more than 5 g/m² requires a large amount of electrical power, which is economically disadvantageous. An anodized layer weight of 1.5 to 4 g/m² is more preferred. It is also desirable for anodizing treatment to be carried out in such a way that the difference in the anodized layer weight between the center of the aluminum alloy plate and areas near the edges is not more than 1 g/m².

Examples of electrolysis apparatuses that may be used in anodizing treatment include those described in JP 48-26638 A, JP 47-18739 A, JP 58-24517 B and JP 2001-11698 A.

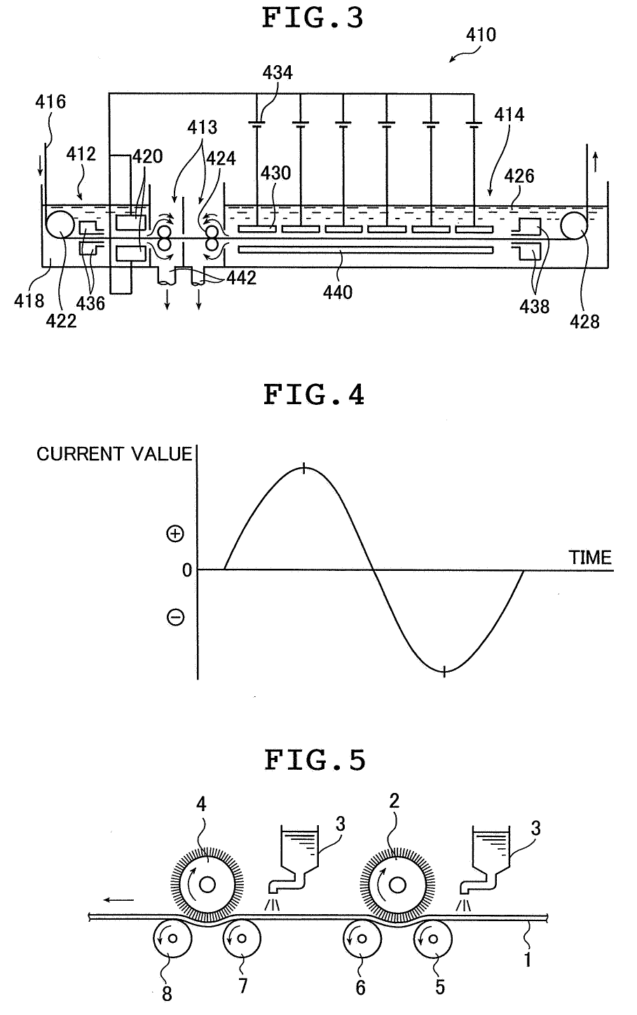

Of these, an apparatus like that shown in FIG. 3 is preferred. FIG. 3 is a schematic view of an apparatus for anodizing the surface of an aluminum alloy plate.

In an anodizing apparatus 410 shown in FIG. 3, to apply a current to an aluminum alloy plate 416 through an electrolytic solution, a power supplying tank 412 is disposed on the upstream side of the aluminum alloy plate 416 in its moving direction and an anodizing treatment tank 414 is disposed on the downstream side. The aluminum alloy plate 416 is moved by path rollers 422 and 428 in the direction indicated by arrows in FIG. 3. The power supplying tank 412 through which the aluminum alloy plate 416 first passes is provided with anodes 420 which are connected to the positive poles of DC power supplies 434; and the aluminum alloy plate 416 serves as the cathode. Hence, a cathodic reaction arises at the aluminum alloy plate 416.

The anodizing treatment tank 414 through which the aluminum alloy plate 416 next passes is provided with a cathode 430 which is connected to the negative poles of the DC power supplies 434; the aluminum alloy plate 416 serves as the anode. Hence, an anodic reaction arises at the aluminum alloy plate 416, and an anodized layer is formed on the surface of the aluminum alloy plate 416.

The aluminum alloy plate 416 and the cathode 430 are separated by an interval of preferably 50 to 200 mm. The cathode 430 may be made of aluminum. To make it easier to vent from the system hydrogen gas generated by the anodic reaction, it is preferable for the cathode 430 to be divided into a plurality of sections in the direction of advance of the aluminum alloy plate 416 rather than to be a single electrode having a broad surface area.

As shown in FIG. 3, it is advantageous to provide, between the power supplying tank 412 and the anodizing treatment tank 414, an intermediate tank 413 which does not hold the electrolytic solution. By providing such an intermediate tank 413, bypass of the current from the anode 420 to the cathode 430 without passing through the aluminum alloy plate 416 can be prevented. It is preferable to minimize the bypass current by providing nip rollers 424 in the intermediate tank 413 to remove the solution remaining on the aluminum alloy plate 416. The solution removed by the nip rollers 424 is discharged to the outside of the anodizing apparatus 410 through discharge outlets 442.

To lower the voltage loss, the electrolytic solution 418 which is supplied to the power supplying tank 412 is set to a higher temperature and/or concentration than an electrolytic solution 426 which is supplied to the anodizing treatment tank 414. Moreover, the composition, temperature and other characteristics of the electrolytic solutions 418 and 426 are set based on such considerations as the anodized layer forming efficiency, the shapes of micropores of the anodized layer, the hardness of the anodized layer, the voltage, and the cost of the electrolytic solution.

The power supplying tank 412 and the anodizing treatment tank 414 are supplied with electrolytic solution injected by solution feed nozzles 436 and 438. To ensure that the distribution of electrolytic solution remains uniform and thereby prevent the localized concentration of current on the aluminum alloy plate 416 in the anodizing treatment tank 414, the solution feed nozzles 436 and 438 have a construction in which slits are provided to keep the flow of injected liquid constant in the width direction.

In the anodizing treatment tank 414, a shield 440 is provided on the opposite side of the aluminum alloy plate 416 from the cathode 430 to inhibit the flow of current to the opposite side of the aluminum alloy plate 416 from the surface on which the anodized layer is to be formed. The interval between the aluminum alloy plate 416 and the shield 440 is preferably 5 to 30 mm. It is preferable to use a plurality of DC power supplies 434 with their positive poles connected in common, thereby enabling control of the current distribution within the anodizing treatment tank 414.

### <Sealing Treatment>

In the practice of the invention, if necessary, sealing treatment may be carried out to close the micropores present in the anodized layer. Sealing treatment may be carried out in accordance with a known method, such as boiling water treatment, hot water treatment, steam treatment, sodium silicate treatment, nitrite treatment or ammonium acetate treatment. For example, sealing treatment may be carried out using the apparatuses and processes described in JP 56-12518 B, JP 4-4194 A, JP 5-202496 A and JP 5-179482 A.

### <Hydrophilizing Treatment>

Hydrophilizing treatment may be carried out after anodizing treatment or after sealing treatment. Illustrative examples of suitable hydrophilizing treatments include the potassium hexafluorozirconate treatment described in U.S. Pat. No. 2,946,638, the phosphomolybdate treatment described in U.S. Pat. No. 3,201,247, the alkyl titanate treatment described in GB 1,108,559 B, the polyacrylic acid treatment described in DE 1,091,433 B, the polyvinylphosphonic acid treatments described in DE 1,134,093 B and GB 1,230,447 B, the phosphonic acid treatment described in JP 44-6409 B, the phytic acid treatment described in U.S. Pat. No. 3,307,951, the treatments involving the divalent metal salts of lipophilic organic polymeric compounds described in JP 58-16893 A and JP 58-18291 A, a treatment like that described in U.S. Pat. No. 3,860,426 in which an aqueous metal salt (e.g., zinc acetate)-containing hydrophilic cellulose (e.g., carboxymethyl cellulose) undercoat is provided, and an undercoating treatment like that described in JP 59-101651 A in which a sulfo group-bearing water-soluble polymer is applied.

Additional examples of suitable hydrophilizing treatments include those which involve undercoating the aluminum alloy plate with the phosphates mentioned in JP 62-19494 A, the water-soluble epoxy compounds mentioned in JP 62-33692 A, the phosphoric acid-modified starches mentioned in JP 62-97892 A, the diamine compounds mentioned in JP 63-56498 A, the inorganic or organic salts of amino acids mentioned in JP 63-130391 A, the carboxy or hydroxy group-bearing organic phosphonic acids mentioned in JP 63-145092 A, the amino group- and phosphonate group-containing compounds mentioned in JP 63-165183 A, the specific carboxylic acid derivatives mentioned in JP 2-316290 A, the phosphate esters mentioned in JP 3-215095 A, the compounds having one amino group and one phosphorus oxo acid group mentioned in JP 3-261592 A, the phosphate esters mentioned in JP 3-215095 A, the aliphatic or aromatic phosphonic acids (e.g., phenylphosphonic acid) mentioned in JP 5-246171 A, the sulfur atom-containing compounds (e.g., thiosalicylic acid) mentioned in JP 1-307745 A, and the phosphorus oxo acid group-bearing compounds mentioned in JP 4-282637 A.

Coloration with an acid dye as mentioned in JP 60-64352 A may also be carried out.

It is preferable to carry out hydrophilizing treatment by a method in which the aluminum alloy plate is immersed in an aqueous solution of an alkali metal silicate such as sodium silicate or potassium silicate, or is coated with a hydrophilic vinyl polymer or a hydrophilic compound so as to form a hydrophilic undercoat.

Hydrophilizing treatment with an aqueous solution of an alkali metal silicate such as sodium silicate or potassium silicate can be carried out according to the processes and procedures described in U.S. Pat. No. 2,714,066 and U.S. Pat. No. 3,181,461.

Illustrative examples of suitable alkali metal silicates include sodium silicate, potassium silicate and lithium silicate. The aqueous solution of an alkali metal silicate may include also a suitable amount of, for example, sodium hydroxide, potassium hydroxide or lithium hydroxide.

The aqueous solution of an alkali metal silicate may include also an alkaline earth metal salt or a Group 4 (Group IVA) metal salt. Examples of suitable alkaline earth metal salts include nitrates such as calcium nitrate, strontium nitrate, magnesium nitrate and barium nitrate; and also sulfates, hydrochlorides, phosphates, acetates, oxalates, and borates. Exemplary Group 4 (Group IVA) metal salts include titanium tetrachloride, titanium trichloride, titanium potassium fluoride, titanium potassium oxalate, titanium sulfate, titanium tetraiodide, zirconyl chloride, zirconium dioxide and zirconium tetrachloride. These alkaline earth metal salts and Group 4 (Group IVA) metal salts may be used singly or in combinations of two or more thereof.

The amount of silicon adsorbed as a result of alkali metal silicate treatment can be measured with a fluorescent x-ray analyzer, and is preferably about 1.0 to 15.0 mg/m².

The alkali metal silicate treatment has the effect of enhancing the resistance at the surface of the lithographic printing plate support to dissolution in an alkali developer, suppressing the leaching of aluminum components into the developer, and reducing the generation of development scum arising from developer fatigue.

Alternatively, hydrophilizing treatment involving the formation of a hydrophilic undercoat can be carried out in accordance with the conditions and procedures described in JP 59-101651 A and JP 60-149491 A.

Hydrophilic vinyl polymers that may be used in such a method include copolymers of a sulfo group-bearing vinyl polymerizable compound such as polyvinylsulfonic acid or sulfo group-bearing p-styrenesulfonic acid with a conventional vinyl polymerizable compound such as an alkyl (meth)acrylate. Examples of hydrophilic compounds that may be used in this method include compounds having at least one group selected from among —NH₂ group, —COOH group and sulfo group.

### <Drying>

After the lithographic printing plate support has been obtained as described above, it is advantageous to dry the surface of the support before providing an image recording layer thereon. Drying is preferably carried out after the support has been rinsed with water and the water removed with nip rollers following the final surface treatment.

The drying temperature is preferably at least 70° C., and more preferably at least 80° C., but preferably not more than 110° C., and more preferably not more than 100° C.

The drying time is preferably at least 1 second, and more preferably at least 2 seconds, but preferably not more than 20 seconds, and more preferably not more than 15 seconds.

### <Control of the Solution Compositions>

In the practice of the invention, it is preferable for the compositions of the various solutions used in the above-described surface treatment to be controlled by the method described in JP 2001-121837 A. This typically involves first preparing a large number of treatment solution samples to various concentrations, then measuring the ultrasonic wave propagation velocity at two solution temperatures for each sample and constructing a matrix-type data table based on the results. During treatment, it is preferable to measure the solution temperature and ultrasonic wave propagation velocity in real time and to control the concentration based on these measurements. In cases where an electrolytic solution having a sulfuric acid concentration of 250 g/L or more is used in desmutting treatment, controlling the concentration by the foregoing method is especially preferred.

The various electrolytic solutions used in electrolytic graining treatment and anodizing treatment preferably have a copper concentration of not more than 100 ppm. If the copper concentration is too high, copper will deposit onto the aluminum alloy plate when the production line stops. When the line starts moving again, the deposited copper may be transferred to the path rollers, which may cause uneven treatment.

### [Presensitized Plate]

A presensitized plate of the invention can be obtained by providing an image recording layer on the lithographic printing plate support of the invention. A photosensitive composition may be used to form the image recording layer.

Preferred examples of photosensitive compositions that may be used in the invention include thermal positive-type photosensitive compositions containing an alkali-soluble polymeric compound and a photothermal conversion substance (such compositions and the image recording layers obtained using these compositions are referred to below as “thermal positive-type” compositions and image recording layers), thermal negative-type photosensitive compositions containing a curable compound and a photothermal conversion substance (such compositions and the image recording layers obtained therefrom are similarly referred to below as “thermal negative-type” compositions and image recording layers), photopolymerizable photosensitive compositions (referred to below as “photopolymer-type” compositions), negative-type photosensitive compositions containing a diazo resin or a photo-crosslinkable resin (referred to below as “conventional negative-type” compositions), positive-type photosensitive compositions containing a quinonediazide compound (referred to below as “conventional positive-type” compositions), and photosensitive compositions that do not require a special development step (referred to below as “non-treatment type” compositions). These preferred photosensitive compositions are described below.

### <Thermal Positive-Type Photosensitive Compositions>

### <Photosensitive Layer>

Thermal positive-type photosensitive compositions contain an alkali-soluble polymeric compound and a photothermal conversion substance. In a thermal positive-type image recording layer, the photothermal conversion substance converts light energy such as from an infrared laser into heat, which efficiently eliminates interactions that lower the alkali solubility of the alkali-soluble polymeric compound.

The alkali-soluble polymeric compound may be, for example, a resin having an acidic group on the molecule, or a mixture of two or more such resins. Resins having an acidic group, such as a phenolic hydroxy group, a sulfonamide group (—SO₂NH—R, wherein R is a hydrocarbon group) or an active imino group (—SO₂NHCOR, —SO₂NHSO₂R or —CONHSO₂R, wherein R is as defined above), are especially preferred on account of their solubility in alkaline developers.

For an excellent image formability with exposure to light from an infrared laser, resins having phenolic hydroxy groups are especially desirable. Preferred examples of such resins include novolak resins such as phenol-formaldehyde resins, m-cresol-formaldehyde resins, p-cresol-formaldehyde resins, cresol-formaldehyde resins in which the cresol is a mixture of m-cresol and p-cresol, and phenol/cresol mixture-formaldehyde resins (phenol-cresol-formaldehyde co-condensation resins) in which the cresol is m-cresol, p-cresol or a mixture of m- and p-cresol.

Additional preferred examples include the polymeric compounds described in JP 2001-305722 A (especially paragraphs [0023] to [0042]), the polymeric compounds having recurring units of general formula (1) described in JP 2001-215693 A, and the polymeric compounds described in JP 2002-311570 A (especially paragraph [0107]).

To provide a good recording sensitivity, the photothermal conversion substance is preferably a pigment or dye that absorbs light in the infrared wavelength range of 700 to 1200 nm. Illustrative examples of suitable dyes include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal-thiolate complexes (e.g., nickel-thiolate complexes). Of these, cyanine dyes are preferred. The cyanine dyes of general formula (I) described in JP 2001-305722 A are especially preferred.

A dissolution inhibitor may be included in thermal positive-type photosensitive compositions. Preferred examples of dissolution inhibitors include those described in paragraphs [0053] to [0055] of JP 2001-305722 A.

The thermal positive-type photosensitive compositions preferably also include, as additives, sensitivity regulators, print-out agents for obtaining a visible image immediately after heating from light exposure, compounds such as dyes as image colorants, and surfactants for enhancing coatability and treatment stability. Compounds as described in paragraphs [0056] to [0060] of JP 2001-305722 A are preferred additives.

Use of the photosensitive compositions described in detail in JP 2001-305722 A is desirable in consideration of additional advantages as well.

The thermal positive-type image recording layer is not limited to a single layer, but may have a two-layer construction.

Preferred examples of image recording layers with a two-layer construction (also referred to as “multilayer-type image recording layers”) include those comprising a bottom layer (“layer A”) of excellent press life and solvent resistance which is provided on the side close to the support and a layer (“layer B”) having an excellent positive-image formability which is provided on layer A. This type of image recording layer has a high sensitivity and can provide a broad development latitude. Layer B generally contains a photothermal conversion substance. Preferred examples of the photothermal conversion substance include the dyes mentioned above.

Preferred examples of resins that may be used in layer A include polymers that contain as a copolymerizable component a monomer having a sulfonamide group, an active imino group or a phenolic hydroxy group; such polymers have an excellent press life and solvent resistance. Preferred examples of resins that may be used in layer B include phenolic hydroxy group-bearing resins which are soluble in aqueous alkali solutions.

In addition to the above resins, various additives may be included, if necessary, in the compositions used to form layers A and B. For example, suitable use can be made of the various additives described in paragraphs [0062] to [0085] of JP 2002-323769 A. The additives described in paragraphs [0053] to [0060] of JP 2001-305722 A as above are also suitable for use.

The components and proportions thereof in each of layers A and B are preferably selected as described in JP 11-218914 A.

<Intermediate Layer>

It is advantageous to provide an intermediate layer between the thermal positive-type image recording layer and the support. Preferred examples of ingredients that may be used in the intermediate layer include the various organic compounds described in paragraph [0068] of JP 2001-305722 A.

<Others>

The methods described in detail in JP 2001-305722 A may be used to form a thermal positive-type image recording layer and to make a printing plate having such a layer.

### <Thermal Negative-Type Photosensitive Compositions>

Thermal negative-type photosensitive compositions contain a curable compound and a photothermal conversion substance. A thermal negative-type image recording layer is a negative-type photosensitive layer in which areas irradiated with light such as from an infrared laser cure to form image areas.

<Polymerizable Layer>

An example of a preferred thermal negative-type image recording layer is a polymerizable image recording layer (polymerizable layer). The polymerizable layer contains a photothermal conversion substance, a radical generator, a radical-polymerizable compound which is a curable compound, and a binder polymer. In the polymerizable layer, the photothermal conversion substance converts absorbed infrared light into heat, and the heat decomposes the radical generator, thereby generating radicals. The radicals then trigger the chain polymerization and curing of the radical-polymerizable compound.

Illustrative examples of the photothermal conversion substance include photothermal conversion substances that may be used in the above-described thermal positive-type photosensitive compositions. Specific examples of cyanine dyes, which are especially preferred, include those described in paragraphs [0017] to [0019] of JP 2001-133969 A.

Preferred radical generators include onium salts. The onium salts described in paragraphs [0030] to [0033] of JP 2001-133969 A are especially preferred.

Exemplary radical-polymerizable compounds include compounds having one, and preferably two or more, terminal ethylenically unsaturated bonds.

Preferred binder polymers include linear organic polymers. Linear organic polymers which are soluble or swellable in water or a weakly alkaline aqueous solution are preferred. Of these, (meth)acrylic resins having unsaturated groups (e.g., allyl, acryloyl) or benzyl groups and carboxy groups in side chains are especially preferred because they provide an excellent balance of film strength, sensitivity and developability.

Radical-polymerizable compounds and binder polymers that may be used include those described specifically in paragraphs [0036] to [0060] of JP 2001-133969 A.

Thermal negative-type photosensitive compositions preferably contain additives described in paragraphs [0061] to [0068] of JP 2001-133969 A (e.g., surfactants for enhancing coatability).

The methods described in detail in JP 2001-133969 A may be used to form a polymerizable layer and to make a printing plate having such a layer.

<Acid-Crosslinkable Layer>

Another preferred thermal negative-type image recording layer is an acid-crosslinkable image recording layer (abbreviated hereinafter as “acid-crosslinkable layer”). The acid-crosslinkable layer contains a photothermal conversion substance, a thermal acid generator, a compound (crosslinker) which is curable and which crosslinks under the influence of an acid, and an alkali-soluble polymeric compound which is capable of reacting with the crosslinker in the presence of an acid. In the acid-crosslinkable layer, the photothermal conversion substance converts absorbed infrared light into heat. The heat decomposes the thermal acid generator, thereby generating an acid which causes the crosslinker and the alkali-soluble polymeric compound to react and cure.

The photothermal conversion substance is exemplified by the same substances as can be used in the polymerizable layer.

Exemplary thermal acid generators include photoinitiators for photopolymerization, dye photochromogenic substances, and heat-decomposable compounds such as acid generators which are used in microresists and the like.

Exemplary crosslinkers include hydroxymethyl- or alkoxymethyl-substituted aromatic compounds, compounds having N-hydroxymethyl, N-alkoxymethyl or N-acyloxymethyl groups, and epoxy compounds.

Exemplary alkali-soluble polymeric compounds include novolak resins and polymers having hydroxyaryl groups in side chains.

### <Photopolymer-Type Photosensitive Compositions>

Photopolymer-type photosensitive compositions contain an addition-polymerizable compound, a photopolymerization initiator and a polymer binder.

Preferred addition-polymerizable compounds include compounds containing an ethylenically unsaturated bond which are addition-polymerizable. Ethylenically unsaturated bond-containing compounds are compounds which have a terminal ethylenically unsaturated bond. Such compounds may have the chemical form of a monomer, a prepolymer, or a mixture thereof. The monomers are exemplified by esters of unsaturated carboxylic acids (e.g., acrylic acid, methacrylic acid, itaconic acid, maleic acid) and aliphatic polyols, and amides of unsaturated carboxylic acids and aliphatic polyamines.

Preferred addition-polymerizable compounds include also urethane-type addition-polymerizable compounds.

The photopolymerization initiator may be any of various photopolymerization initiators or a system of two or more photopolymerization initiators (photoinitiation system) which is suitably selected according to the wavelength of the light source to be used. Preferred examples include the initiation systems described in paragraphs [0021] to [0023] of JP 2001-22079 A.

The polymer binder, inasmuch as it must function as a film-forming agent for the photopolymerizable photosensitive composition and, at the same time, must allow the image recording layer to dissolve in an alkaline developer, should be an organic polymer which is soluble or swellable in an alkaline aqueous solution. Preferred examples of such organic polymers include those described in paragraphs [0036] to [0063] of JP 2001-22079 A.

It is preferable for the photopolymer-type photosensitive composition to include the additives described in paragraphs [0079] to [0088] of JP 2001-22079 A (e.g., surfactants for improving coatability, colorants, plasticizers, thermal polymerization inhibitors).

To prevent oxygen from inhibiting polymerization, it is preferable to provide an oxygen-blocking protective layer on top of the photopolymer-type image recording layer. The polymer present in the oxygen-blocking protective layer is exemplified by polyvinyl alcohols and copolymers thereof.

It is also desirable to provide an intermediate layer or a bonding layer like those described in paragraphs [0124] to [0165] of JP 2001-228608 A.

### <Conventional Negative-Type Photosensitive Compositions>

Conventional negative-type photosensitive compositions contain a diazo resin or a photo-crosslinkable resin. Among others, photosensitive compositions which contain a diazo resin and an alkali-soluble or swellable polymeric compound (binder) are preferred.

The diazo resin is exemplified by condensation products of an aromatic diazonium salt with an active carbonyl group-bearing compound such as formaldehyde; and organic solvent-soluble diazo resin inorganic salts which are the reaction products of a hexafluorophosphate or tetrafluoroborate with the condensation product of a p-diazophenylamine and formaldehyde. The high-molecular-weight diazo compounds described in JP 59-78340 A, in which the content of hexamer and larger polymers is at least 20 mol %, are especially preferred.

Exemplary binders include copolymers containing acrylic acid, methacrylic acid, crotonic acid or maleic acid as an essential component. Specific examples include the multi-component copolymers of such monomers as 2-hydroxyethyl (meth)acrylate, (meth)acrylonitrile and (meth)acrylic acid described in JP 50-118802 A, and the multi-component copolymers of alkyl acrylates, (meth)acrylonitrile and unsaturated carboxylic acids described in JP 56-4144 A.

Conventional negative-type photosensitive compositions preferably contain as additives the print-out agents, dyes, plasticizers for imparting flexibility and wear resistance to the applied coat, development promoters and other compounds, and the surfactants for enhancing coatability described in paragraphs [0014] to [0015] of JP 7-281425 A.

Below the conventional negative-type photosensitive layer, it is advantageous to provide the intermediate layer which contains a polymeric compound having an acid group-bearing component and an onium group-bearing component described in JP 2000-105462 A.

### <Conventional Positive-Type Photosensitive Compositions>

Conventional positive-type photosensitive compositions contain a quinonediazide compound. Photosensitive compositions containing an o-quinonediazide compound and an alkali-soluble polymeric compound are especially preferred.

Illustrative examples of the o-quinonediazide compound include esters of 1,2-naphthoquinone-2-diazido-5-sulfonyl chloride and a phenol-formaldehyde resin or a cresol-formaldehyde resin, and the esters of 1,2-naphthoquinone-2-diazido-5-sulfonyl chloride and pyrogallol-acetone resins described in U.S. Pat. No. 3,635,709.

Illustrative examples of the alkali-soluble polymeric compound include phenol-formaldehyde resins, cresol-formaldehyde resins, phenol-cresol-formaldehyde co-condensation resins, polyhydroxystyrene, N-(4-hydroxyphenyl)methacrylamide copolymers, the carboxy group-bearing polymers described in JP 7-36184 A, the phenolic hydroxy group-bearing acrylic resins described in JP 51-34711 A, the sulfonamide group-bearing acrylic resins described in JP 2-866 A, and urethane resins.

Conventional positive-type photosensitive compositions preferably contain as additives the compounds such as sensitivity regulators, print-out agents and dyes described in paragraphs [0024] to [0027] of JP 7-92660 A, and surfactants for enhancing coatability such as those described in paragraph [0031] of JP 7-9.2660 A.

Below the conventional positive-type photosensitive layer, it is advantageous to provide an intermediate layer similar to the intermediate layer which is preferably used in the case of the above-described conventional negative-type photosensitive layer.

### <Non-Treatment Type Photosensitive Compositions>

Illustrative examples of non-treatment type photosensitive compositions include thermoplastic polymer powder-based photosensitive compositions, microcapsule-based photosensitive compositions, and sulfonic acid-generating polymer-containing photosensitive compositions. All of these are heat-sensitive compositions containing a photothermal conversion substance. The photothermal conversion substance is preferably a dye of the same type as those which can be used in the above-described thermal positive-type photosensitive compositions.

Thermoplastic polymer powder-based photosensitive compositions are composed of a hydrophobic, heat-meltable finely divided polymer dispersed in a hydrophilic polymer matrix. In the thermoplastic polymer powder-based image recording layer, the fine particles of hydrophobic polymer melt under the influence of heat generated by light exposure and mutually fuse, forming hydrophobic regions which serve as the image areas.

The finely divided polymer is preferably one in which the particles melt and fuse together under the influence of heat. A finely divided polymer in which the individual particles have a hydrophilic surface, enabling them to disperse in a hydrophilic component such as dampening water, is especially preferred. Preferred examples include the finely divided thermoplastic polymers described in Research Disclosure No. 33303 (January 1992), JP 9-123387 A, JP 9-131850 A, JP 9-171249 A, JP 9-171250 A and EP 931,647 A. Of these, polystyrene and polymethyl methacrylate are preferred. Illustrative examples of finely divided polymers having a hydrophilic surface include those in which the polymer itself is hydrophilic, and those in which the surfaces of the polymer particles have been rendered hydrophilic by adsorbing thereon a hydrophilic compound such as polyvinyl alcohol or polyethylene glycol.

The finely divided polymer preferably has reactive functional groups.

Preferred examples of microcapsule-type photosensitive compositions include those described in JP 2000-118160 A, and compositions like those described in JP 2001-277740 A in which a compound having thermally reactive functional groups is enclosed within microcapsules.

Illustrative examples of sulfonic acid-generating polymers that may be used in sulfonic acid generating polymer-containing photosensitive compositions include the polymers described in JP 10-282672 A that have sulfonate ester groups, disulfone groups or sec- or tert-sulfonamide groups in side chains.

Including a hydrophilic resin in a non-treatment type photosensitive composition not only provides a good on-press developability, it also enhances the film strength of the photosensitive layer itself. Preferred hydrophilic resins include resins having hydrophilic groups such as hydroxy, carboxy, hydroxyethyl, hydroxypropyl, amino, aminoethyl, aminopropyl or carboxymethyl groups; and hydrophilic binder resins of a sol-gel conversion-type.

A non-treatment type image recording layer can be developed on the press, and thus does not require a special development step. The methods described in detail in JP 2002-178655 A may be used as the method of forming a non-treatment type image recording layer and the associated plate making and printing methods.

### <Back Coat>

If necessary, the presensitized plate of the invention obtained by providing any of the various image recording layers on a lithographic printing plate support obtained according to the invention may be provided on the rear side with a coat composed of an organic polymeric compound to prevent scuffing of the image recording layer when the presensitized plates are stacked on top of each other.

### [Lithographic Plate Making Process]

The presensitized plate prepared using a lithographic printing plate support obtained according to the invention is then subjected to any of various treatment methods depending on the type of the image recording layer, thereby obtaining a lithographic printing plate.

Illustrative examples of sources of actinic light that may be used for imagewise exposure include mercury vapor lamps, metal halide lamps, xenon lamps and chemical lamps. Examples of laser beams that may be used include those from helium-neon lasers (He—Ne lasers), argon lasers, krypton lasers, helium-cadmium lasers, KrF excimer lasers, semiconductor lasers, YAG lasers and YAG-SHG lasers.

Following the above exposure, if the image recording layer is of a thermal positive type, thermal negative type, conventional negative type, conventional positive type or photopolymer type, it is preferable to carry out development using a developer in order to prepare a lithographic printing plate.

The developer is preferably an alkaline developer, and more preferably an alkaline aqueous solution which is substantially free of organic solvent.

Developers which are substantially free of alkali metal silicates are also preferred. One example of a suitable method of development using a developer which is substantially free of alkali metal silicates is the method described in detail in JP 11-109637 A.

Developers which contain an alkali metal silicate may also be used.

### EXAMPLES

Hereinafter, the present invention is described in detail by way of examples.

### Examples 1 to 7 and Comparative Examples 1 to 3

### Manufacture of Aluminum Alloy Plate and Lithographic Printing Plate Support

Aluminum members (Al-1 to Al-8) of compositions shown in Table 1 were subjected to heat treatment steps shown in Table 2 to adjust the silicon and iron contents in solid solution as shown in Table 2, then subjected to continuous casting to produce aluminum alloy plates.

The thus produced aluminum alloy plates were subjected to the following surface roughening treatment to yield lithographic printing plate supports.

TABLE 1

| | | | | Others | |
|---|---|---|---|---|---|
| Composition | Si (wt %) | Fe (wt %) | Cu (wt %) | (wt %) | Balance |
| A1-1 | 0.1 | 0.1 | 0.020 | 0.05 | Al |
| A1-2 | 0.12 | 0.25 | 0.000 | 0.05 | Al |
| A1-3 | 0.2 | 0.4 | 0.002 | 0.05 | Al |
| A1-4 | 0.15 | 0.25 | 0.005 | 0.05 | Al |
| A1-5 | 0.2 | 0.2 | 0.005 | 0.05 | Al |
| A1-6 | 0.1 | 0.4 | 0.002 | 0.05 | Al |
| A1-7 | 1 | 0.4 | 0.002 | 0.05 | Al |
| A1-8 | 0.2 | 1 | 0.005 | 0.05 | Al |

### <Surface Roughening Treatment I>

Surface roughening treatment I including the following treatment steps (a) to (e) were carried out. Rinsing treatment was carried out among all the treatment steps.

(a) Alkali Etching Treatment

Etching treatment was carried out by using a spray line to spray each of the produced aluminum alloy plates with an aqueous solution having a sodium hydroxide concentration of 25 wt %, an aluminum ion concentration of 100 g/L, and a temperature of 60° C. The amount of material removed by etching from the side of the aluminum alloy plate to be subsequently subjected to electrochemical graining treatment was 5 g/m².

(b) Desmutting Treatment

Next, desmutting treatment was carried out by spraying the aluminum alloy plate with an aqueous solution of 1 wt % nitric acid (solution temperature, 35° C.) from a spray line for 5 seconds.

(c) Electrolytic Graining Treatment

Electrochemical graining treatment was consecutively carried out using a 60 Hz AC voltage in an electrolytic solution (solution temperature: 50° C.) obtained by dissolving aluminum nitrate in an aqueous solution of 1 wt % nitric acid to have an aluminum ion concentration of 4.5 g/L. Electrochemical graining was carried out for a period of time TP until the current reached a peak from zero of 0.8 ms, at a duty ratio (ratio of the anodic reaction time in one cycle) of 0.5, using an alternating current having a waveform shown in FIG. 1, with a carbon electrode as the counter electrode. Ferrite was used as the auxiliary anode. Two electrolytic cells of the type shown in FIG. 2 were used.

In this electrochemical graining treatment, the current density at the alternating current peak during the anodic reaction of the aluminum alloy plate was 60 A/dm². The ratio of the total amount of electricity furnished for the anodic reaction to that furnished for the cathodic reaction at the aluminum alloy plate was 0.95. The amount of electricity, which is the total amount of electricity when the aluminum alloy plate serves as an anode, was 190 C/dm². Of the current that flows from the power supply, 5% was diverted to the auxiliary anode. The average speed of the aluminum alloy plate relative to the electrolytic solution within the electrolytic cell was 1.5 m/s.

(d) Alkali Etching Treatment

Etching treatment was carried out by using a spray line to spray the aluminum alloy plate with an aqueous solution having a sodium hydroxide concentration of 5 wt %, an aluminum ion concentration of 5 g/L, and a temperature of 35° C. The amount of material removed by etching from the side of the aluminum alloy plate that has been subjected to electrochemical graining treatment was 0.1 g/m².

(e) Desmutting Treatment

Desmutting treatment was carried out by spraying the aluminum alloy plate with an aqueous solution having a sulfuric acid concentration of 300 g/L, an aluminum ion concentration of 5 g/L and a temperature of 35° C. from a spray line for 5 seconds.

The methods described below were applied to each of the lithographic printing plate supports obtained by carrying out surface roughening treatment I to thereby measure the silicon and iron contents in solid solution and pit diameter and check the uniformity of the electrolytically grained surface and whether or not there was an appearance defect. The results were shown in Table 2.

### (Measurement of Silicon and Iron Contents in Solid Solution)

The silicon and iron contents in solid solution were measured by a dissolution/extraction process using phenol.

More specifically, the specimen of each lithographic printing plate support obtained was dissolved in hot phenol, followed by addition of benzyl alcohol. Then, the mixture was filtered through a polytetrafluoroethylene filter to remove the intermetallic compound residue. Then, the filtrate was diluted with benzyl alcohol, followed by extraction of silicon and iron in the solution. The extract was quantified by the standard addition ICP-MS method.

The silicon and iron contents in solid solution in each lithographic printing plate support are similar to those in the aluminum alloy substrate used for the manufacture thereof.

### (Evaluation of Uniformity of Electrolytically Grained Surface)

The surface of each lithographic printing plate support after electrolytic graining treatment was examined under a scanning electron microscope (SEM) (5500, manufactured by JEOL Ltd.) at a magnification of 2,000× to evaluate the graining uniformity based on the following criteria:

Excellent: At least 90% of the pits formed have a circular opening;

Good: At least 50% but less than 90% of the pits formed have a circular opening;

Fair: At least 10% but less than 50% of the pits formed have a circular opening;

Poor: Less than 10% of the pits formed have a circular opening.

### (Whether there is Appearance Defect)

The surface of each lithographic printing plate support after electrolytic graining treatment was visually observed under white light to check whether or not there was an appearance defect. Evaluation was made based on the following criteria:

Excellent: There is no overall density unevenness or streaky unevenness;

Good: There is no density unevenness but streaky unevenness occurs at less than 10% of the entire surface;

Fair: There is density unevenness and streaky unevenness occurs at 10% or more but less than 50% of the entire surface;

Poor: the entire surface has considerable density unevenness and streaky unevenness.

### (Pit Diameter)

The surface of each lithographic printing plate support after electrolytic graining treatment was observed under an electron microscope at magnifications of 500× and 2,000× (at an angle of 0° in each case). Evaluation was made based on the following criteria:

A: Pits having an average opening diameter of 0.01 to 0.05 μm and those having an average opening diameter of 0.05 to 1.5 μm were uniformly formed at the entire surface;

B: Pits having an average opening diameter of 0.01 to 0.05 μm or 0.05 to 1.5 μm were uniformly formed at the entire surface;

C: Pits having an average opening diameter of 0.01 to 0.05 μm were formed at a ratio (surface ratio) of up to 20% with respect to the entire surface;

D: Pits having an average opening diameter of more than 1.5 μm were formed at a ratio (surface ratio) of at least 20% with respect to the entire surface.

### <Surface Roughening Treatment II>

Surface roughening treatment II including the following treatment steps (a) to (e) were carried out. Rinsing treatment was carried out among all the treatment steps.

(a) Mechanical Graining Treatment

Each of the produced aluminum alloy plates was subjected to brush graining in an aqueous suspension of pumice having a particle size (median diameter) of 30 μm (specific gravity: 1.5).

(b) Alkali Etching Treatment

Then, etching treatment was carried out by using a spray line to spray the produced aluminum alloy plate with an aqueous solution having a sodium hydroxide concentration of 25 wt %, an aluminum ion concentration of 100 g/L, and a temperature of 60° C. The amount of material removed by etching from the side of the aluminum alloy plate to be subsequently subjected to electrochemical graining treatment was 0.3 g/m².

(c) Desmutting Treatment

Next, desmutting treatment was carried out by spraying the aluminum alloy plate with an aqueous solution of 1 wt % nitric acid (solution temperature, 30° C.) from a spray line for 10 seconds.

(d) Electrolytic Graining Treatment

Electrochemical graining treatment was consecutively carried out using a 60 Hz AC voltage in an electrolytic solution (solution temperature: 50° C.) obtained by dissolving aluminum nitrate in an aqueous solution of 1 wt % nitric acid to have an aluminum ion concentration of 4.5 g/L. Electrochemical graining was carried out for a period of time TP until the current reached a peak from zero of 0.8 ms, at a duty ratio (ratio of the anodic reaction time in one cycle) of 0.5, using an alternating current having a waveform shown in FIG. 1, with a carbon electrode as the counter electrode. Ferrite was used as the auxiliary anode. Two electrolytic cells of the type shown in FIG. 2 were used.

In this electrochemical graining treatment, the current density at the alternating current peak during the anodic reaction of the aluminum alloy plate was 60 A/dm². The ratio of the total amount of electricity furnished for the anodic reaction to that furnished for the cathodic reaction at the aluminum alloy plate was 0.95. The amount of electricity which is the total amount of electricity when the aluminum alloy plate serves as an anode, was 190 C/dm². Of the current that flows from the power supply, 5% was diverted to the auxiliary anode. The average speed of the aluminum alloy plate relative to the electrolytic solution within the electrolytic cell was 1.5 m/s.

(e) Desmutting Treatment

Desmutting treatment was carried out by spraying the aluminum alloy plate with an aqueous solution having a sulfuric acid concentration of 300 g/L and a temperature of 60° C. from a spray line for 3 seconds.

The above-described methods were applied to each of the lithographic printing plate supports obtained by carrying out surface roughening treatment II to thereby measure the silicon and iron contents in solid solution and pit diameter and check the uniformity of the electrolytically grained surface and whether or not there was an appearance defect. The results were shown in Table 2.

### <Surface Roughening Treatment III>

Surface roughening treatment III including the following treatment steps (a) to (k) were carried out. Rinsing treatment was carried out among all the treatment steps.

(a) Mechanical Graining Treatment (Brush Graining)

Mechanical graining treatment was carried out with rotating roller-type nylon brushes of an apparatus as schematically shown in FIG. 5 while feeding an abrasive slurry in the form of an aqueous suspension of an abrasive (pumice) having a specific gravity of 1.12 g/cm³ to the surface of the aluminum alloy plate. FIG. 5 shows an aluminum alloy plate 1, roller-type brushes 2 and 4, an abrasive-containing slurry 3, and support rollers 5, 6, 7 and 8.

The abrasive used had an average particle size of 40 μm and a maximum particle size of 100 μm. The nylon brushes were made of nylon 6/10 and had a bristle length of 50 mm and a bristle diameter of 0.3 mm. Each brush was constructed of a 300 mm diameter stainless steel cylinder in which holes had been formed and bristles densely set. Three rotating brushes were used. Two support rollers (200 mm diameter) were provided below each brush and spaced 300 mm apart. The brush rollers were pressed against the aluminum alloy plate until the load on the driving motor that rotates the brushes was 7 kW greater than before the brush rollers were pressed against the plate. At the contact portions between the brushes and the aluminum alloy plate, the direction in which the brushes were rotated was the same as the direction in which the aluminum alloy plate was moved. The rotation speed of the brushes was 200 rpm.

(b) Alkali Etching Treatment

Etching treatment was carried out by using a spray line to spray the produced aluminum alloy plate with an aqueous solution having a sodium hydroxide concentration of 26 wt %, an aluminum ion concentration of 6.5 wt %, and a temperature of 70° C. The amount of material removed by etching from the aluminum alloy plate was 10 g/m². Rinsing was subsequently carried out by spraying it with water.

(c) Desmutting Treatment

Desmutting treatment was carried out by spraying the plate with an aqueous solution having a nitric acid concentration of 1 wt % (aluminum ion content, 0.5 wt %) and a temperature of 30° C. from a spray line. Rinsing was subsequently carried out by spraying it with water. The wastewater from the electrolytic graining treatment step using an alternating current in an aqueous nitric acid solution was used for the aqueous nitric acid solution in desmutting treatment.

(d) Electrolytic Graining Treatment

Electrochemical graining treatment was consecutively carried out using a 60 Hz AC voltage. The electrolytic solution used was an aqueous solution of 10.5 g/L nitric acid (containing 5 g/L of aluminum ions and 0.007 wt % of ammonium ions) that had a liquid temperature of 50° C. Electrochemical graining was carried out for a period of time TP until the current reached a peak from zero of 0.8 ms, at a duty ratio of 1:1, using an alternating current having a waveform shown in FIG. 1, with a carbon electrode as the counter electrode. Ferrite was used as the auxiliary anode. An electrolytic cell of the type shown in FIG. 2 was used.

The current density at the current peak was 30 A/dm². The amount of electricity, which is the total amount of electricity when the aluminum alloy plate serves as an anode, was 220 C/dm². Of the current that flows from the power supply, 5% was diverted to the auxiliary anode.

Rinsing was subsequently carried out by spraying it with water.

(e) Alkali Etching Treatment

Etching treatment was carried out by using a spray line to spray the aluminum alloy plate with an aqueous solution having a sodium hydroxide concentration of 26 wt % and an aluminum ion concentration of 6.5 wt % at a temperature of 60° C. and 1.0 g/m² of material was dissolved from the aluminum alloy plate to remove the aluminum hydroxide-based smut component generated when the electrolytic graining treatment using the alternating current was carried out in the previous step. Edges of pits formed were also dissolved to be given smooth surfaces. Rinsing was subsequently carried out by spraying it with water.

(f) Desmutting Treatment

Desmutting treatment was carried out by spraying the aluminum alloy plate with an aqueous solution having a sulfuric acid concentration of 15 wt %, an aluminum ion concentration of 4.5 wt % and a temperature of 30° C. from a spray line. Rinsing was subsequently carried out by spraying it with water. The wastewater from the electrolytic graining treatment step using the alternating current in the aqueous nitric acid solution was used for the aqueous nitric acid solution in desmutting treatment.

(g) Electrolytic Graining Treatment

Electrochemical graining treatment was consecutively carried out using a 60 Hz AC voltage. The electrolytic solution used was an aqueous solution of 7.5 g/L hydrochloric acid (containing 5 g/L of aluminum ions) that had a liquid temperature of 35° C. Electrochemical graining was carried out for a period of time TP until the current reached a peak from zero of 0.8 ms, at a duty ratio of 1:1, using an alternating current having a waveform shown in FIG. 1, with a carbon electrode as the counter electrode. Ferrite was used as the auxiliary anode. An electrolytic cell of the type shown in FIG. 2 was used.

The current density at the current peak was 25 A/dm². The amount of electricity, which is the total amount of electricity when the aluminum alloy plate serves as an anode, was 50 C/dm². Of the current that flows from the power supply, 5% was diverted to the auxiliary anode.

Rinsing was subsequently carried out by spraying it with water.

(h) Alkali Etching Treatment

Etching treatment was carried out by using a spray line to spray the aluminum alloy plate with an aqueous solution having a sodium hydroxide concentration of 26 wt % and an aluminum ion concentration of 6.5 wt % at a temperature of 32° C. and 0.5 g/m² of material was dissolved from the aluminum alloy plate to remove the aluminum hydroxide-based smut component generated when the electrolytic graining treatment using the alternating current was carried out in the previous step. Edges of pits formed were also dissolved to be given smooth surfaces. Rinsing was subsequently carried out by spraying it with water.

(i) Desmutting Treatment

Desmutting treatment was carried out by spraying the plate with an aqueous solution having a sulfuric acid concentration of 25 wt % (aluminum ion content, 0.5 wt %) and a temperature of 60° C. from a spray line. Rinsing was subsequently carried out by spraying it with water.

(j) Anodizing Treatment

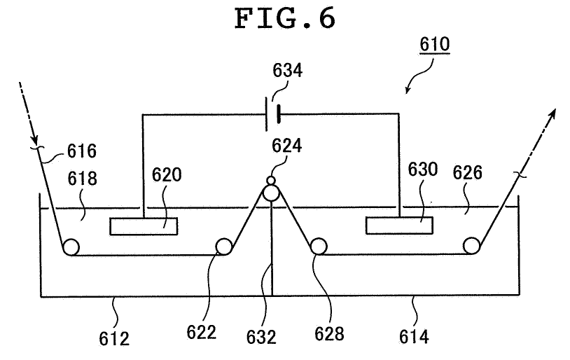

An anodizing apparatus of the structure as shown in FIG. 6 was used to carry out anodizing treatment. Sulfuric acid was used for the electrolytic solution for supplying to a first and a second electrolysis portion. Each electrolytic solution contained 170 g/L of sulfuric acid (and 0.5 wt % of aluminum ions) and had a temperature of 38° C. Then, each aluminum alloy plate was sprayed with water for rinsing. The final weight of the anodized layer was 2.7 g/m².

(k) Hydrophilizing Treatment

Hydrophilizing treatment (alkali metal silicate treatment) was carried out on the aluminum alloy plate by immersing it in an aqueous solution containing 1 wt % of No. 3 sodium silicate (temperature: 20° C.) for 10 seconds. Thereafter, the plate was rinsed by spraying with well water.

Each of the lithographic printing plate supports obtained by carrying out surface roughening treatment III was measured for the silicon and iron contents in solid solution and pit diameter, and checked for the uniformity of the electrolytically grained surface and whether or not there was an appearance defect. The results were shown in Table 2.

TABLE 2

| | | | Si | Fe | Uniformity of | | | Whether there is | | | | | |
|---|---|---|---|---|---|---|---|---|---|---|---|---|---|
| | | | content | content | electrolytically grained | | | appearance defect | | | Pit diameter | | |
| | Al | Heat | in solid | in solid | surface | | | Condi- | | | Condi- | Condi- | Condi- |
| | compo- | treatment | solution | solution | Condition | Condition | Condition | tion | Condition | Condition | tion | tion | tion |
| | sition | condition | (ppm) | (ppm) | I | II | III | I | II | III | I | II | III |
| EX1 | A1-1 | 400° C. × 10 h | 200 | 70 | Good | Good | Excellent | Good | Good | Excellent | B | B | A |
| EX2 | A1-2 | 450° C. × 15 h | 350 | 40 | Good | Good | Excellent | Good | Good | Excellent | B | B | A |
| EX3 | A1-2 | 500° C. × 10 h | 400 | 50 | Good | Good | Excellent | Good | Good | Excellent | B | B | A |
| EX4 | A1-3 | 500° C. × 10 h | 450 | 250 | Good | Good | Excellent | Good | Good | Excellent | B | B | A |
| EX5 | A1-4 | 500° C. × 10 h | 300 | 200 | Good | Good | Excellent | Good | Good | Excellent | B | B | A |
| EX6 | A1-5 | 500° C. × 10 h | 500 | 150 | Good | Good | Excellent | Good | Good | Excellent | B | B | A |
| EX7 | A1-6 | 500° C. × 10 h | 220 | 200 | Good | Good | Excellent | Good | Good | Excellent | B | B | A |
| CE1 | A1-7 | 550° C. × 25 h | 1000 | 250 | Poor | Poor | Poor | Poor | Poor | Poor | D | D | C |
| CE2 | A1-8 | 550° C. × 25 h | 200 | 400 | Poor | Poor | Poor | Poor | Poor | Poor | D | D | C |
| CE3 | A1-1 | 350° C. × 10 h | 80 | 50 | Fair | Fair | Good/Fair | Fair | Fair | Good/Fair | D | D | D |

### [Manufacture of Presensitized Plate]

Presensitized plates for lithographic printing were fabricated by providing a thermal positive-type image recording layer on each of the lithographic printing plate supports obtained by carrying out surface roughening treatment III. Un undercoat as described below was applied prior to forming the image recording layer.

An undercoating solution of the composition indicated below was applied onto the respective lithographic printing plate supports and dried at 80° C. for 15 seconds, thereby forming the undercoat. The weight of the undercoat after drying was 15 mg/m².

### <Composition of Undercoating Solution>

| Polymeric compound of the following formula | 0.3 | g |
|---|---|---|
| 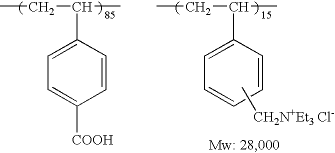 | | |
| Methanol | 100 | g |
| Water | 1 | g |

In addition, a heat-sensitive layer coating solution of the composition indicated below was prepared. This solution was applied onto the undercoated lithographic printing plate supports and dried to obtain a dried coating weight (heat-sensitive layer coating weight) of 1.8 g/m², thus forming a heat-sensitive layer (thermal positive-type image recording layer) and giving presensitized plates.

### <Composition of Heat-Sensitive Layer Coating Solution>

| | | |
|---|---|---|
| Novolak resin (m-cresol/p-cresol = 60/40; weight-awerage | 0.90 | g |
| molecular weight, 7,000; unreacted | | |
| cresol content, 0.5 wt %) | | |
| Ethyl methacrylate/isobutyl methacrylate/methacrylic | 0.10 | g |
| acid copolymer (molar ratio: 35/35/30) | | |
| Cyanine Dye A of the following structural | 0.1 | g |
| formula | | |

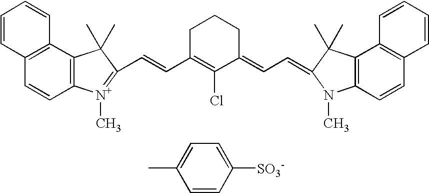

| | | |
|---|---|---|
| Tetrahydrophthalic anhydride | 0.05 | g |
| p-Toluenesulfonic acid | 0.002 | g |
| Dye obtained by changing counterion in Ethyl Violet to | 0.02 | g |
| 6-hydxoxy-β-naphthalenesulfonic acid | | |
| Fluorochemical surfactant (megaface F-780F, | 0.0045 | g |
| available from Dainippon Ink and Chemicals, | | |
| Inc.; solids content, 30 wt %) | | |
| (solids) | | |
| Fluorochemical surfactant (megaface F-781F, | 0.035 | g |
| available from Dainippon Ink and Chemicals, | | |
| Inc.; solids content, 100 wt %) | | |
| Methyl ethyl ketone | 12 | g |

The resulting presensitized plates were imagewise exposed using a Trendsetter (manufactured by Creo) at a drum rotation speed of 150 rpm and a beam intensity of 10 W.

Next, development was carried out over a period of 20 seconds using a PS Processor 940H (manufactured by FUJIFILM Corporation) charged with an alkaline developer of the composition indicated below while holding the developer at a temperature of 30° C., thereby giving lithographic printing plates.

### <Alkaline Developer Composition>

| | |
|---|---|
| D-Sorbit | 2.5 wt % |
| Sodium hydroxide | 0.85 wt % |
| Polyethylene glycol lauryl ether (weight-average | 0.5 wt % |
| molecular weight, 1,000) | |
| Water | 96.15 wt % |

The resulting presensitized plates were subjected to exposure and development to evaluate the press life and scumming resistance of the lithographic printing plates. The results were shown in Table 3.

### (Evaluation of Scumming Resistance)

The scumming resistance was evaluated by visually inspecting the blanket for staining after 10,000 impressions had been printed on a Mitsubishi Daiya F2 printing press (Mitsubishi Heavy Industries, Ltd.) with DIC-GEOS (s) Magenta ink (Dainippon Ink and Chemicals, Inc.) using the lithographic printing plates obtained above. Evaluation was made based on the following criteria:

A: The blanket was not stained;

B: The blanket was hardly stained;

C: The blanket was slightly stained;

D: The blanket was stained within a tolerable level;

E: The blanket was stained, causing impressions to be clearly stained;

F: The blanket was significantly stained;

G: The blanket was heavily stained.

### (Evaluation of Press Life)

The press life was evaluated by printing copies from the resulting printing plate on a Lithrone printing press (manufactured by Komori Corporation) using DIC-GEOS(N) black ink (Dainippon Ink and Chemicals, Inc.) and determining the total number of impressions that were printed until the density of solid images began to noticeably decline on visual inspection.

TABLE 3

| | | Si content | Fe content | | |
|---|---|---|---|---|---|
| | Al | in solid | in solid | | Press life |
| | compo- | solution | solution | Scumming | (10,000's |
| | sition | (ppm) | (ppm) | resistance | of units) |
| Example 1 | A1-1 | 200 | 70 | A | 10 |
| Example 2 | A1-2 | 350 | 40 | A | 9 |
| Example 3 | A1-2 | 400 | 50 | A | 11 |
| Example 4 | A1-3 | 450 | 250 | A | 11 |
| Example 5 | A1-4 | 300 | 250 | A | 9 |
| Example 6 | A1-5 | 500 | 50 | A | 12 |
| Example 7 | A1-6 | 220 | 200 | A | 9 |
| Comparative | A1-7 | 1000 | 250 | E | 7.5 |
| Example 1 | | | | | |
| Comparative | A1-8 | 200 | 400 | G | 6 |
| Example 2 | | | | | |
| Comparative | A1-1 | 80 | 50 | C | 7 |
| Example 3 | | | | | |

The results shown in Table 3 revealed that the presensitized plates in Examples 1 to 7 obtained by carrying out surface roughening treatment III enable the lithographic printing plates resulting therefrom to be more excellent in both of the scumming resistance and press life than in the presensitized plates obtained in Comparative Examples 1 to 3.

What is claimed is:

1. An aluminum alloy plate for a lithographic printing plate obtained by continuous casting in which an aluminum alloy melt is fed through a melt feed nozzle between a pair of cooling rollers and rolled as it is being solidified by the pair of cooling rollers,
wherein the aluminum alloy plate contains 0.10 to 0.20 wt % of silicon and 0.10 to 0.40 wt % of iron, and
wherein the aluminum alloy plate contains in solid solution 200 to 600 ppm of silicon and not more than 250 ppm of iron.

2. The aluminum alloy plate for a lithographic printing plate according to claim 1, wherein copper is contained in an amount of not more than 0.02 wt %.

3. A lithographic printing plate support obtained by subjecting a surface of the aluminum alloy plate for a lithographic printing plate according to claim 1 to a surface roughening treatment including an electrochemical graining treatment.

4. The lithographic printing plate support according to claim 3, wherein the surface roughening treatment further includes an alkali etching treatment prior to the electrochemical graining treatment.

5. The lithographic printing plate support according to claim 3, wherein pits formed by the electrochemical graining treatment have uniform diameters of 0.01 to 1.5 μm.

6. The lithographic printing plate support according to claim 3, wherein the surface roughening treatment further includes an alkali etching treatment following the electrochemical graining treatment.

7. The lithographic printing plate support according to claim 6, wherein the electrochemical graining treatment is carried out at a current density of at least 5 A/dm², and wherein at least 0.1 g/m² of material is dissolved from the surface of the aluminum alloy plate for a lithographic printing plate by the alkali etching treatment following the electrochemical graining treatment.

8. The lithographic printing plate support according to claim 3, wherein the electrochemical graining treatment is a treatment carried out with an alternating current having a trapezoidal waveform in a nitric acid-containing electrolytic solution.

9. The lithographic printing plate support according to claim 3, wherein the electrochemical graining treatment is a treatment carried out with an alternating current having a sinusoidal waveform in a hydrochloric acid-containing electrolytic solution.

10. The lithographic printing plate support according to claim 3 obtained by the surface roughening treatment which includes a first electrochemical graining treatment carried out in a nitric acid-containing electrolytic solution so that a total amount of electricity in an anodic reaction is from 65 to 500 C/dm², a first alkali etching treatment in which at least 0.1 g/m² of material is dissolved from the surface of the aluminum alloy plate for a lithographic printing plate, a second electrochemical graining treatment carried out in a hydrochloric acid-containing electrolytic solution so that a total amount of electricity in an anodic reaction is from 25 to 100 C/dm², and a second alkali etching treatment in which at least 0.03 g/m² of material is dissolved from the surface of the aluminum alloy plate for a lithographic printing plate.

11. A presensitized plate comprising:
the lithographic printing plate support according to claim 3; and
an image recording layer formed on the lithographic printing plate support.
